(19) United States
(12) Patent Application Publication
(10) Pub. No.: US 2007/0011071 A1
(43) Pub. Date: Jan. 11, 2007

(54) Systems and methods for strategic financial independence planning

(76) Inventors: Samuel Thomas Cuscovitch, Coventry, CT (US); Peter George Pappas, Danbury, CT (US); David Yale Schlossman, Burlingame, CA (US)

Correspondence Address: SAMUEL T. CUSCOVITCH, 147 OAKWOOD DRIVE, COVENTRY, CT, 06238, US

(21) Appl. No.: 11/473,503

(22) Filed: Jun. 23, 2006

Related U.S. Application Data
(60) Provisional application No. 60/693,989, filed on Jun. 23, 2005.

(51) Int. Cl. G06Q 40/00

(52) U.S. Cl. 705/35

(57) ABSTRACT

The present invention relates to financial planning and retirement planning systems, particularly to systems and methods for deriving and measuring the feasibility of a client's retirement across a diverse set of financial domains. Output is made available in a variety of formats suiting different client needs including views, formatted documents and document exports accessible on demand or schedule by external computing systems. The intention is to help clients take primary ownership with respect to issues related to their retirement readiness and improve strategic decision making under an experimental framework capable of deriving, comparing and optimizing a multitude of cases that simulate future uncertainty. The invention specifies a client-server and producer-consumer distributed architecture, decomposed and integrated into various data and functional layers. Modularity is one result of the architecture, enabling the invention to be deployed in various configurations.

### RELATED

This application claims priority from U.S. Provisional Application Ser. No. 60/693,989 filed on Jun. 23, 2005, by Samuel T Cuscovitch, David Y Schlossman, and Peter G Pappas, included by reference herein and for which benefit of the priority date is hereby claimed.

### FIELD OF THE INVENTION

The present invention relates to financial planning and retirement planning systems and more specifically to systems and methods for deriving and measuring the feasibility of a client's retirement plan across a diverse spectrum of financial domains.

### BACKGROUND OF THE INVENTION

It is generally believed the nation faces a significant retirement crises due to a confluence of factors: the growing number of retirees; growing national debt, making programs traditionally relied on by retirees (social security, Medicare) less reliable; decline of pension plans that offer secure lifetime payouts; lack of national savings, recently “negative”; yet, an increased retirement resources need due to longer life spans.

Recent studies and surveys (Federal Reserve “Recent Changes in U.S. Family Finances: Evidence from the 2001 and 2004 Survey of Consumer Finances”) suggest that prospective retirees (“prospects”) appear to be ill-prepared. A 2006 survey by Wachovia Bank found that 31% of the pre-retirees, ages 35-64, with household income exceeding $75,000 felt “intimidated and helpless” about the inadequacy of their retirement savings. Reuters reports a 2005 Fidelity Investments study found that two out of three workers in their final year before retirement had not completed a budget or plan for retirement.

A successful retirement hinges on future events and developments over 20-30 year time spans. While each person has a measure of control and predictability over one's own life-style choices, success also depends on unpredictable and uncontrollable factors including new products, new legislation, and tax code.

The subject matter that affects personal finance is fairly broad and non-uniform. This invention divides subject matter into a comprehensive list of key financial domains. Financial domains include, but are not limited to: Investments; Defined Benefit programs; Insurance; Financial Assets and Liabilities; Real Estate; Taxes; Commodities; Collectibles; Well Being. These domains can be further subcategorized. An individual's comprehensive financial picture is then the sum of financial domains. Though the different financial domains can be “modeled” independently, domain interdependency and recursion exists and are not adequately addressed by current financial planning systems.

Some might suggest that given the factors outlined above, the complexity of retirement planning is so comprehensive and dynamic that a solution process is not feasible. The authors of this invention disagree.

Services, systems and methods exist to reportedly aid a prospective retiree in their effort to: 1) assess their retirement readiness status, (2) identify gaps or shortfalls, and (3) recommend ways to close gaps. Yet surveys indicate that while prospective retirees say they believe in the merits of planning, few do plan because of process complexity; expense/time commitment; distrust of these aids, and denial that they have significant gaps in their retirement plans.

Those that do decide to plan need to select resources such as to (a) do-it-themselves, engage a retirement planner or adviser, or a combination of these two approaches. The client's next decision is “selection” of “tools” like self-developed spreadsheets, guidelines from retirement cookbooks or financial media enabled by web calculators, and sophisticated computer programs, such as those embodied by U.S. Pat. Nos. 6,021,397; 6,058,376; and 5,933,815.

Similarly, a client when utilizing services of an adviser, the client is required to make a “selection”. There are over 500,000 retirement planners or advisers in the U.S. wearing the suits of certified financial planners investment advisors, CPA's, tax attorneys, bankers, and insurance specialists. Their advertised services range from domain specific to comprehensive, and from free to fee. The adviser “process” includes data collection, diagnosis, and recommendations. Clients view the data collection as tedious and invasive, the diagnosis as narrow and the recommendations as out-of-date, unrealistic or biased.

The advisor selection produces out-of-date and unrealistic recommendations because life changes occur during the planning process. There are unexpected events in the client's life: spousal death or divorce, job loss; unexpected windfall, a desire to alter life-style, a bear or bull stock market, the elimination or reduction of a pension plan.

Current retirement planning practices are tactical and deterministic. Retirement planning is best applied as a strategic planning exercise with wide coverage (inclusive of various financial domains), interdependencies, dynamic change, and risks & uncertainties over an extended timeframe. Strategic methods such as “Real Options, Managing Strategic Investment in a Real World”, Martha Amram, Nalin Kulatilaka or “Theory of Games and Statistical Decisions”, David Blackwell and M. A. Girshick are rarely applied or understood by advisers.

Domain coverage holes —A recent Federal Reserve survey indicates that consumers' real estate net worth dwarfs that of all other assets. “Increasingly, the Home Is Paying for Retirement”, NY Times, Feb. 24, 2006. While sixty million Americans have a financial stake in a pension program, the coverage and counsel given to this domain pales in comparison to advice in the investment domain.

Analytic inconsistency across domains —Methods used to address uncertainty are either not applied or incorrectly applied. Stochastic modeling is often used to project investment returns under future volatility for given client financial risk level. Yet, stochastic modeling is absent in application to other domains having great financial importance like real estate, debt, taxes.

Bias —Financial advice is expensive usually afforded by only households of high net worth. “Free” or low-cost financial advice, usually in the Investment domain, carries hidden commissioned sales of financial products hardly unbiased. Consumers' skepticism and cynicism are justified in this regard.

Excess compliance or regulation —The financial industry is a maze of rules that limit customer visibility of strategic alternatives. One example is the common questionnaire used to determine client risk tolerance. How can the customer characterize themselves without knowing the relationship of risk choices to the long range impact? Additionally, risk tolerance is rarely uniformly applied to all client domains. For example, the ability to apply risk tolerance factors to an Adjustable Rate Mortgage client will have revealed risk in advance.

It is therefore an objective of the invention to widen the scope of retirement planning by extending domain coverage and providing a formal framework that treats domains with equal coverage, depth, and consistency.

It is another object of the invention to provide strategic analysis that is neutral with respect to any domain.

It is another object of the invention to strengthen problem solving through appropriate application of deterministic and stochastic methods.

It is another object of the invention to empower the client such that, if a client decides to utilize an adviser, the client has an option to decide the nature of the control relationship with the adviser, aside from full delegation.

It is another object of the invention to provide a holistic tool that is widely available to clients at all levels of the net worth strata.

It is another object of the invention to enable a client, at a time and place convenient to the client to perform indepedently, supporting “planning, as a dynamic process”, rather than as a one-time exercise.

It is another object of the invention to make planning more affordable to the underserved mass market.

It is another object of the invention to support clients' need for privacy, by eliminating intrusiveness as an objection for planning.

It is another object of the invention to offer its capabilities to external systems using open-architecture interface specifications.

It is another object of the invention to provide a holistic tool, whether used by the client directly or through the designated client's proxy, such as an adviser.

### SUMMARY OF THE INVENTION

The invention is capable of producing a client's scenario or financial projections, for the purpose of planning retirement, based on comprehensive and holistic analysis of financial domains relative to a client's financial situation. By holistic, a system must broadly cover financial domains consistent with the current availability and evolution of domain expert systems, and evaluate domains uniformly and with parity. By long range projections, we mean probabilistic projections from the client's current age until a client's estimated mortality.

Methods include the use of mathematics including, but not limited to, mathematical programming, experimental design, graph theory, control theory, heuristic reasoning, and deterministic and stochastic models. These modeling methods, in conjunction with financial strategies, are designed to generate an optimum scenario that maximizes the probability of a successful retirement given a client's current financial state and retirement preferences.

The results are formatted in either machine readable or human readable formats, on demand or on schedule. By machine readable we mean automatic data export formats that comply with common industry standards such WSDL and SOAP/XML, allowing other computerized systems to request and then further process the invention's results in some fashion without human intervention. By human readable formats we mean popular document or worksheet presentations for viewing, printing, e-mailing and electronically filing, such as Adobe PDF or Microsoft Excel or Word.

Central to the design of the invention is the highly systematic approach to applying analytical procedures and methods to data structures that guarantee the complete and automatic delivery of a full scale retirement projection as a computerized producer-consumer model. This type of model is in current use for systems in a variety of narrowly defined niche industries such as stock market quotes. The invention's application of the producer-consumer model as a foundation to a strategic financial planning and retirement projection system with optional levels of client-defined input and output requirements finally enables any consumer client (human or machine/system) a simple and comprehensive method to access well defined and unbiased results across multiple domains.

This approach allows the invention to be applied at will as often as desired to broad varieties of applications such as estate planning, financial and retirement planning, insurance or long-term care planning, career planning, and others. Wth this architecture, the invention is equally accessible to either type of client, human or machine/system, without external human assistance, training or guidance. Specifications of domain, client, and architecture are formal and can be mapped into a hierarchical schema, intended for uses by the invention itself or for financial purposes that the client agrees to outside this invention.

Systems and methods applied by the invention provide for dynamic real-time updates of frequently changing information at the level of abstraction needed for strategic planning purposes.

A scenario processor contains many of the essential elements of the invention, including elements that perform integrated analysis across different financial domains; various automated procedures to generate strategies and cases within an experimental framework required for rigorous analysis.

### BRIEF DESCRIPTION OF THE DRAWINGS

A complete understanding of the present invention may be obtained by reference to the accompanying drawings, when considered in conjunction with the detailed description that follows, in which:

FIG. 1 is a schematic block diagram of the possible deployment of the invention.

FIG. 2 is a state diagram perspective of a clients possible interaction with the invention;

FIG. 3 is a schematic view of the financial domain hierarchy, including of financial domains and subcategories within.

FIG. 4 is a class view schematic of the financial domain architecture;

FIG. 5 is a schematic functional block that illustrates three domain methods referenced in FIG. 4, specific to the Investment domain;

FIG. 6 is a class view schematic of the client architecture, partitioned according to deterministic and non-deterministic components;

FIG. 7 is a state diagram view of a client, updated and referred to by other processes during financial case runs;

FIG. 8 is a schematic depiction of two of the four architectural components of a formalized financial strategy.

FIG. 9 is a schematic functional block for creating strategic decision priority variants, used in conjunction with FIG. 8, as a third architectural component of a financial strategy;

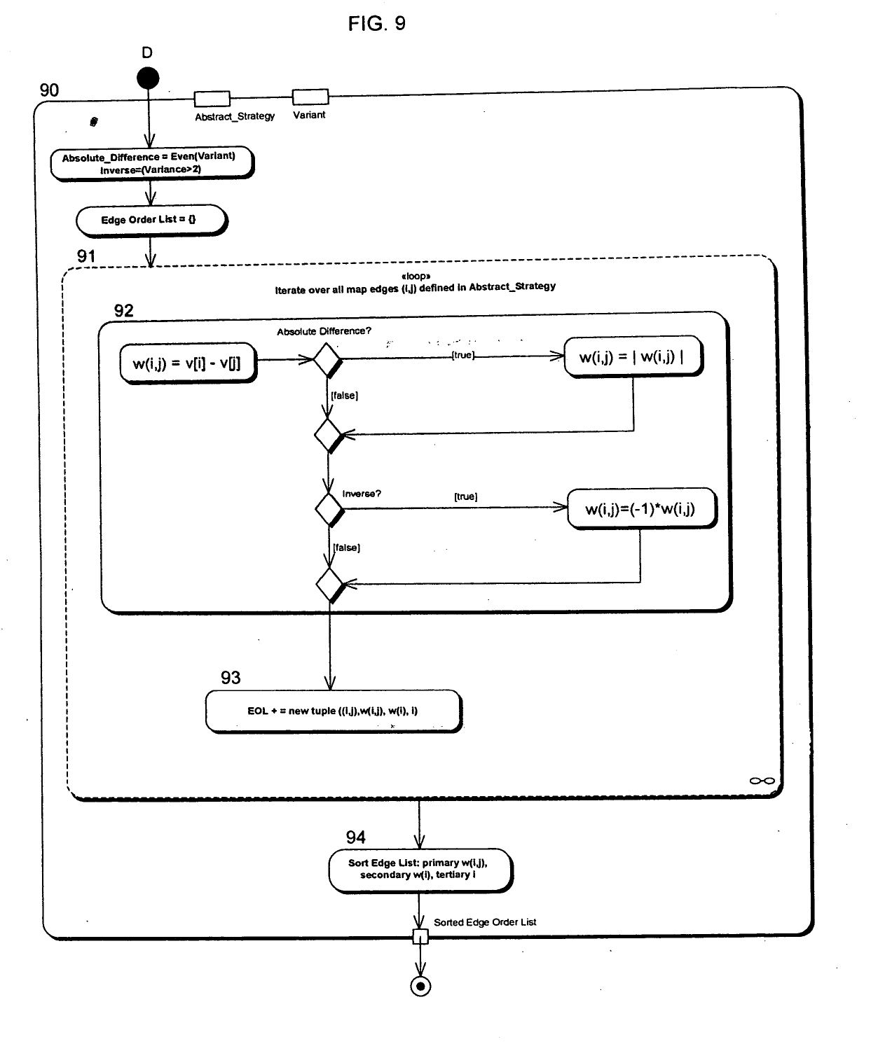

FIG. 10 is a schematic depiction of a decision trigger, used in conjunction with FIG. 8 and FIG. 9, as a fourth architectural component of a financial strategy;

FIG. 11 is a schematic functional block of a scenario processor, containing the outer loop processing steps required to complete the analysis of one client scenario;

FIG. 12 is a schematic functional block to complete the deterministic portion of a clients income and expense (CIE) data container for a given client scenario, referenced in FIG. 11;

FIG. 13 is a schematic functional block to create a minimum of two dissimilar, competing financial strategies, required as part of scenario processing, referenced in FIG. 11;

FIG. 14 is a schematic functional block that executes a full set of experimental case runs, as specified by the experimental design framer, as referenced in FIG. 11;

FIG. 15 is a schematic functional block that identifies process control with respect to the interaction of the client, financial domains and strategy related to a financial case run L, as referenced in FIG. 14;

FIG. 16 is a schematic functional block of a stochastic net cash flow calculation method, referenced in FIG. 15, derived from deterministic and stochastic components;

FIG. 17 is a schematic functional block of a net cash flow addition algorithm, referenced in FIG. 15;

FIG. 18 is a schematic functional block of an executable financial strategy, referenced in FIG. 15;

FIG. 19 is a schematic view of the output data architecture, the basis for reporting and communicating client scenario results, as referenced in FIG. 11.

For purposes of clarity and brevity, like elements and components will bear the same designations and numbering throughout the Figures.

### DESCRIPTION OF THE PREFERRED EMBODIMENT

Deployment

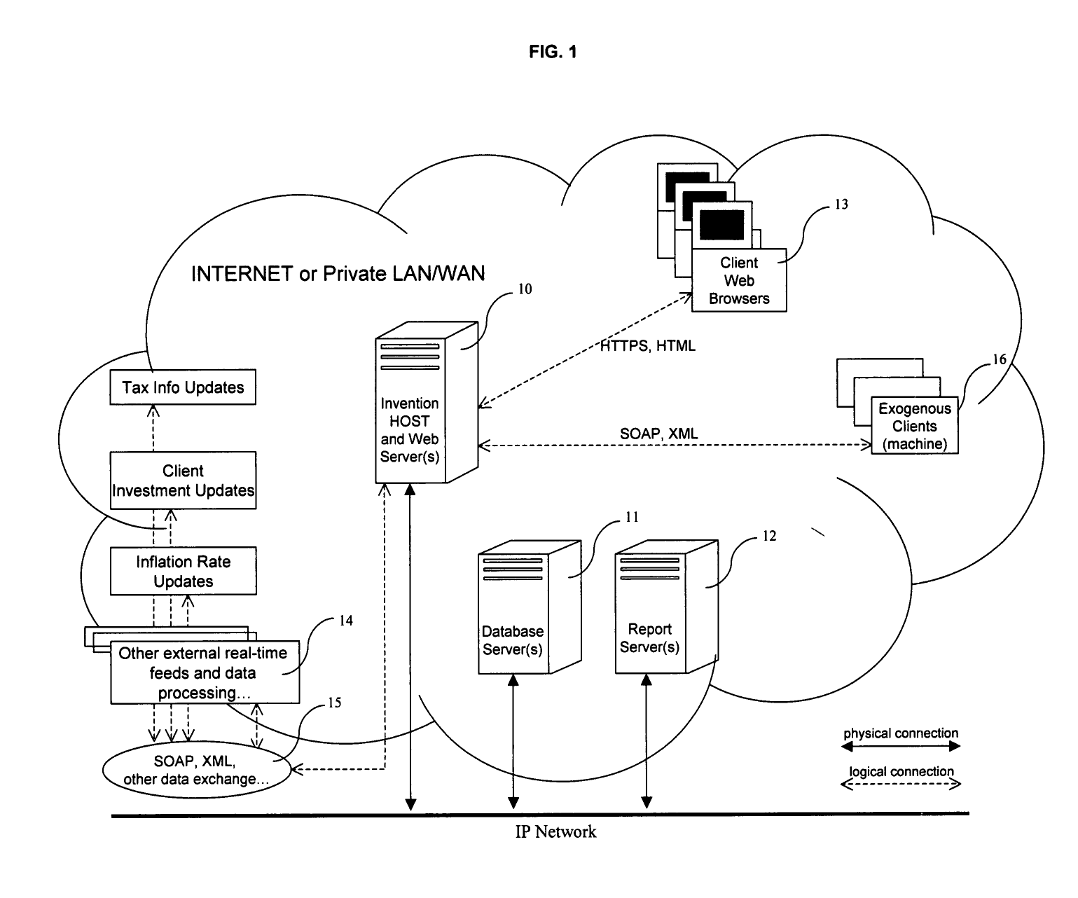

FIG. 1 presents one example for deployment of the invention as a system operating on the Internet (i.e. World Wide Web) or on a private Intranet network. In this example, the invention is deployed on a HOST and Web Server computer serving common public access requests 10. Another embodiment, also referred to in FIG. 1, is a similar HOST server residing on a private Intranet or Local Area Network or Wide Area Network (LAN/WAN) for use internal to a professional or commercial organization.

The HOST Server 10 refers to this embodiment of the invention residing as software on a general purpose computer. Another embodiment of the invention might be an embedded hardware solution where the invention resides as firmware on dedicated computing equipment residing on a network. FIG. 1 also shows a Web Server 10 such as Microsoft's 2003 Server co-located with the HOST Server and providing Internet or Intranet connections and services to clients. While the HOST Server and Web Server are not dependent on each other as co-located servers, this embodiment reflects a typical deployment.

The HOST Web Server is connected directly to the Ethernet (IP) network in a similar fashion to other dependent server computers with dedicated functions for handling requests associated with database repository access 11 and report generation 12. Reports requested through the HOST Server may be targeted to views through client browser viewers such as Microsoft's Internet Explorer or Adobe's Acrobat Reader, or targeted data exports such as Microsoft Word or Excel.

As a system deployed in a public network (Internet) or otherwise in a private LAN/WAN fashion, the system grants access to any qualified user through a client web browser 13 such as Microsoft's Internet Explorer or the Mozilla Firefox browser. User qualifications may be met through a form of subscription in which a user name and password are issued and required for access to a single client account. The FinancialMedic, LLC web service called “Retireport” is an example of such a system with a similar Internet deployment model used.

The server hosting the system 10 is capable of managing any number of client accounts and any number of concurrent sessions with clients, thus portraying a client-server model of operation. Furthermore, more than one server may be deployed in what is commonly referred to as a clustered server configuration, further increasing the number of concurrent client sessions supported. Communication with qualified clients over the Internet using the HTTP protocol is further secured using popular encryption protocols such as Secure Socket Layer (SSL) and deployed over the common web browser protocol HTTPS. In this fashion, client interaction is possible directly via the HTML language standard for web browsers.

Under the w3.org approved standards for data definition (WSDL) and data manipulation and exchange (SOAP, XML) 15, the host system makes use of a machine data interface as a “consumer” of necessary relevant information provided online from other external sources 14. These sources typically exist as independent systems offering combinations of analysis and data exchanges with consumer processes at strictly a machine-to-machine level for either a fee or at no charge.

Frequent updates to this information are then possible as a mechanism to maintain timeliness and accuracy of results in a completely automatic fashion. Examples of this producer-consumer model, where the host system in this case is a consumer, are reflected in related external general or special purpose items 14 such as stock ticker value updates, inflation rate calculations, insurance rate quotes, tax tables, and other data or logic used in various calculations.

In addition to client browsers 13 operated directly by humans via a web browser accessing the system at any time in a classic client-server fashion, another form of requests for analysis and reports may also exist at a machine data level. Again using the defined SOAP protocol, a remote system makes a consumer request of the HOST Server as a different type of client (i.e., an exogenous client 16). In this example, the host system acts as the “producer” and the exogenous client as the “consumer”. Results are communicated to the consumer in an XML format as opposed to the HTML format referred to earlier in the human client, web browser example.

Similar to the human oriented web interface which requires no intermediate tier of interaction between client requests and server results (i.e. integration, analysis and reports are all automatic), the SOAP, XML interface also operates at an autonomous level free from manual intervention of any kind. Requests through this data oriented interface are provided the same flexibility and completeness as the human interface.

Reporting and Presentation

The invention's reporting mechanisms are the methods used to communicate results to the client using either a human or a machine interface as described earlier. The two approaches to reporting then fall into two categories:

Formatted viewer reports for web browser access. These reports are presented on screen and may then be printed, saved or e-mailed at request by the user. Typically reports accessed under these circumstances are managed by a report server 12 such as Microsoft Report Server or Business Objects Crystal Vision Server.

Data oriented (XML or other formats) reports for consumer requests from other systems 16 are issued directly from the host system. Report output of this type may be used as input for other types of reporting, presentation or analysis. As an example, a scheduled export of data may feed an external “desktop dashboard system” which presents projections in a graphical form (dials, switches, graphs) using different shapes, colors and metrics to identify “safe” versus “high risk” situations. Another example may be periodic data reporting to an external system focused on historical trending and analysis.

Reports may be scheduled or requested in ad hoc fashion, serving either class of client, human or machine. In addition, reports may be triggered by events based on other parameters such as a fixed percentage increase or decrease in an investment over a given time period; or an observed increase or decrease in the calculated inflation rate over a given time period.

Reports that reflect the thorough integration of data across the different domains referenced earlier are then possible through the system's logically defined methods, current report definitions and access to the appropriate database repository.

As a personalized, financial strategy system devoted to financial independence, report content is particularly important. The ability to produce certain content requires a full understanding of the client, domain, strategy, and the related scenario output architecture.

Interaction with Invention

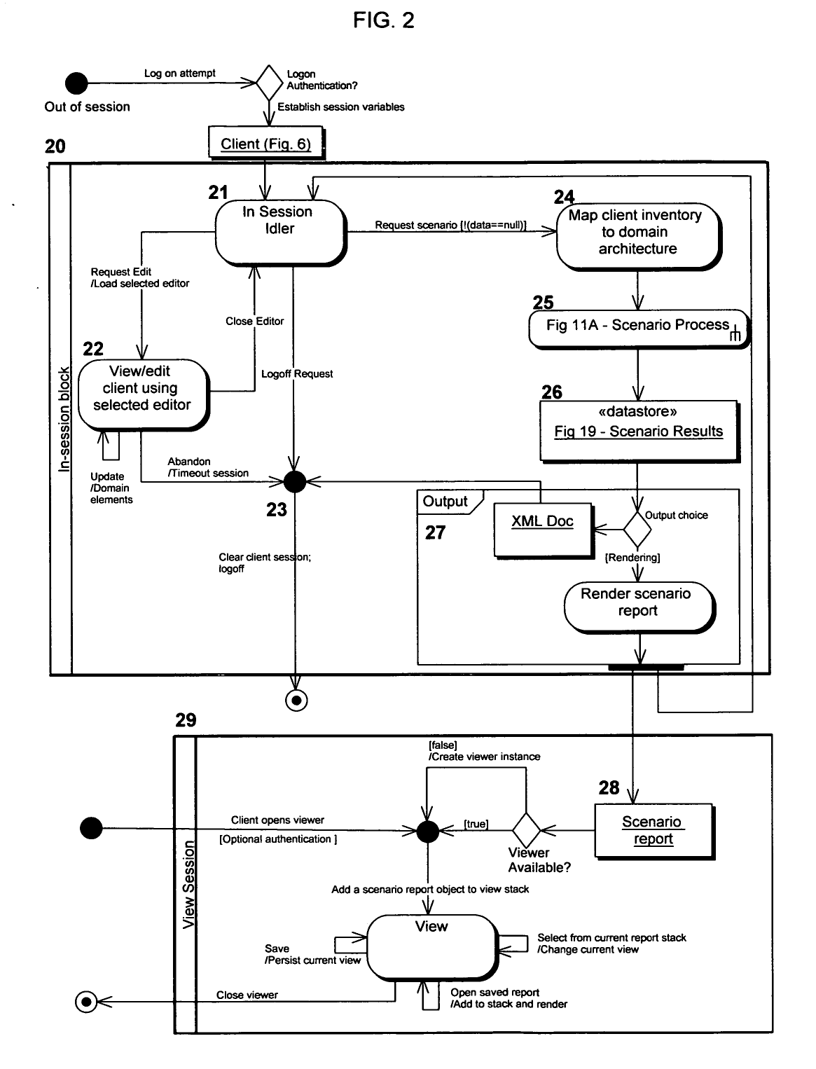

FIG. 2 illustrates how a requestor interacts with the invention, described using a state diagram. The requestor may be the client or an entity operating on behalf of a client and may be: (1) a human being using a web-browser, or (2) an automated system as is commonly known as producer-consumer configuration. Both requesters represent a client-server configuration.

Two main sessions are represented on FIG. 2 the primary session in block 20 and the view session in block 29. The primary session 20 is a collection of activities associated with editing client data 22, generating client scenarios in blocks 24-26, and rendering reports 27. The view session is only meaningful after having previously generated at least one scenario. The primary and view sessions can operate autonomously.

A requestor logs on and must be authenticated to establish a primary session. Authentication creates a unique session identifier (ID) valid only for the session and tied to a specific client ID or [symbol] handle [symbol] . The logical link between session ID and client handle lasts only for the session. The client handle is used to retrieve that clients data in the data repository, a relational data base server such as Microsoft SQL Server. While [symbol] in session [symbol] , client data is encapsulated in a client object in server memory. The client object is accessible to all FIG. 2 processes and many of its contained processes.

Upon authentication, the requester is placed in an “in session” idle state 21, waiting for the next command. Requestor choices include: (1) edit the client description 22, or (2) generate a client scenario 24, or (3) logoff 23. The requestor may also “abandon” (i.e. close the session without an explicit logoff) after a designated time interval (i.e. timeout). All session closures clear the client's object from the server [symbol] s memory. Unexpected data loss may be the result of abandonment. Saving client data in the repository allows the client description to persist across sessions.

A request to edit the client [symbol] s description 22 requires a choice of an edit viewer. Once the requestor decides to conclude the editing session, an explicit update would store the changes in the data repository. A client [symbol] s normal completion of an edit process results in the closure of the editor [symbol] s viewer. The client is returned to the idle state 21, awaiting the requestor [symbol] s next command.

If the requestor wishes to analyze a client scenario with the intent to render a scenario report, the request is first screened to determine whether the request is in good order. For example, an empty client data set would not be in good order, suggesting no editing has ever taken place.

A scenario request is fulfilled by completing a series of processes in blocks 24 [symbol] 28. A subset of the client [symbol] s persistent data is [symbol] loaded [symbol] and [symbol] mapped [symbol] into the financial domain hierarchy 24, a process that reformats the data stored in the repository to the format expected by the financial domain models. Format conversion may be necessary if the domain is an external expert system (i.e. communicable through internet proxies or adapters). In addition, global variables are given to the domains for use as a common critical assumption. For example, the discount rate may be critical in converting from future value to present value, which financial domains may need to uniformly calculate.

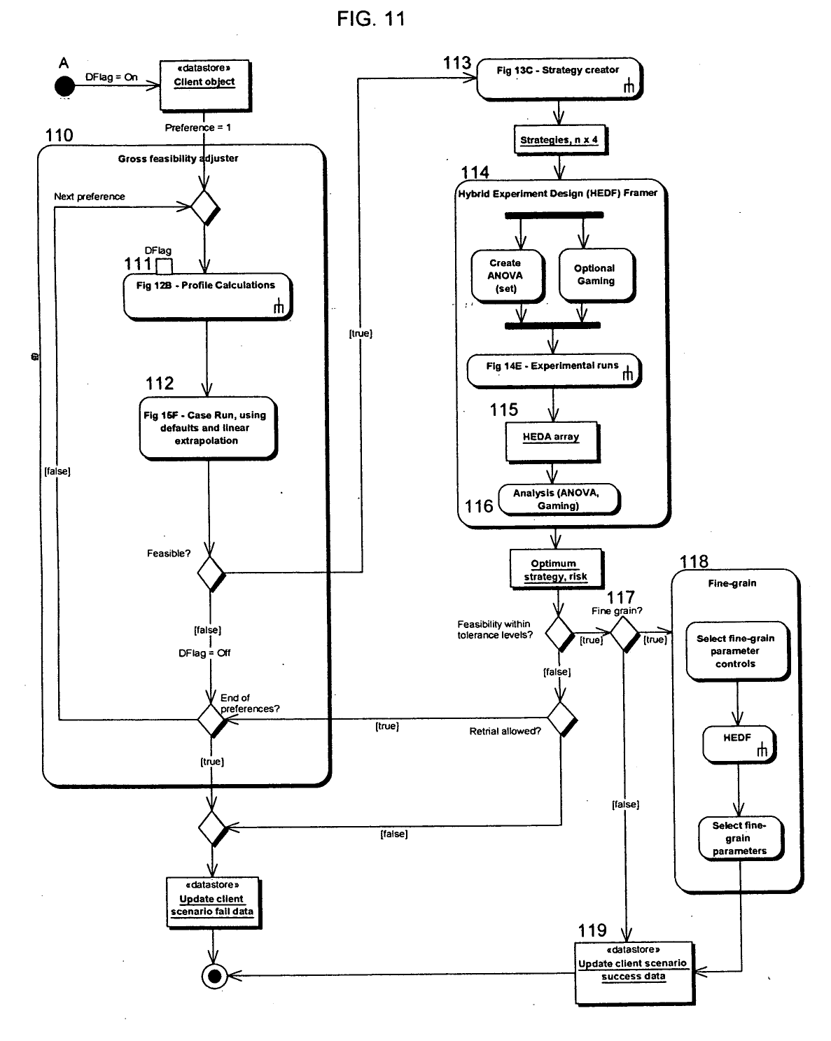

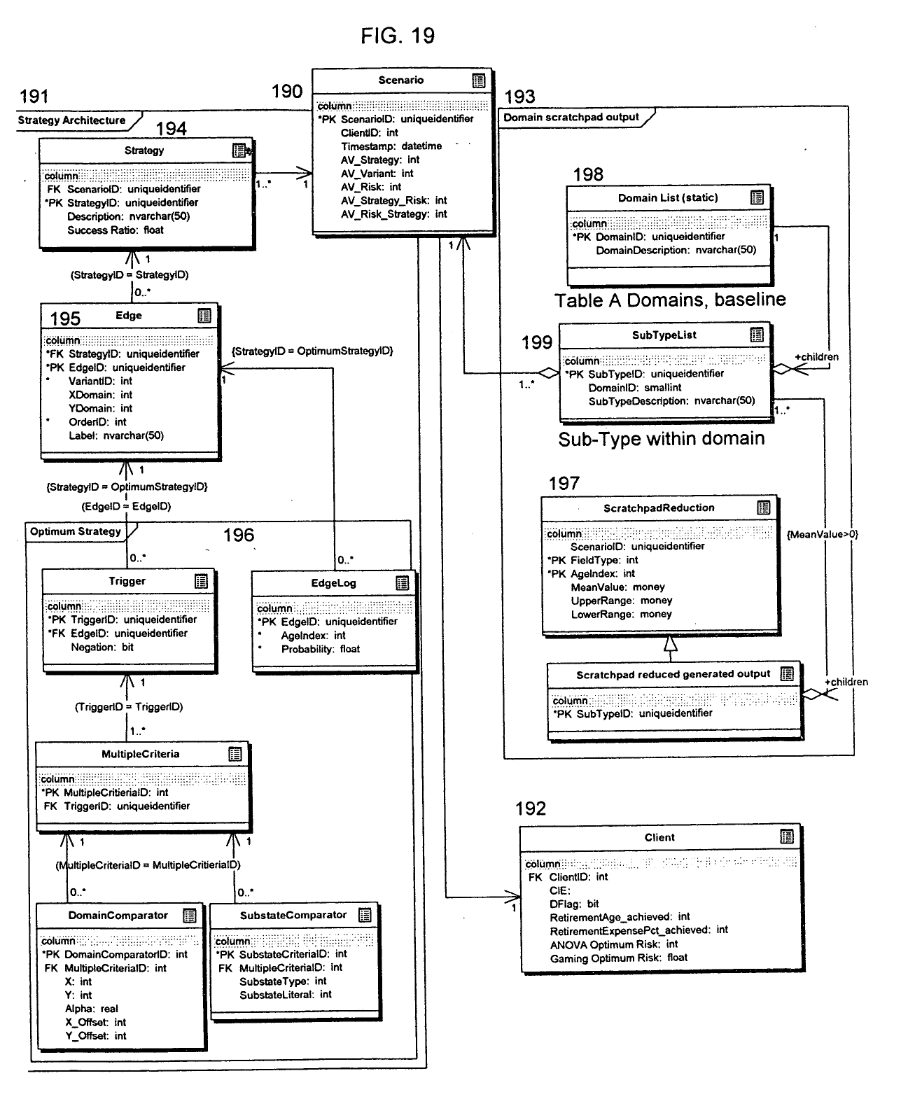

The scenario processor in block 25 executes a series of processes, including functional blocks described in FIG. 11-FIG. 18. This process outputs a scenario dataset, comprised of a range of tables, record types and data elements, made persistent in the data repository 26 or encapsulated in an XML document and delivered back to the requester. A unique key ties persistent scenario output data to this specific scenario run for this client, as described in FIG. 19.

Next, a request is made to a dedicated and specialized server known as a “report server”, e.g. Microsoft [symbol] s Report Server. The request typically renders pre-designed reports 27, with choice of delivery modes including: (1) the immediate real-time delivery to the requestor, via web-browser or other machine (XML) language or, (2) a delayed, scheduled delivery by various electronic means, such as electronic mail to the requestor or other designated parties, or (3) made accessible through the use of report management tools, enabling client the flexibility to design reports limited by data and report access rights granted by system administrators.

The rendering process creates a report object 28. Under mode (1) above, the report is returned immediately to the requestor. Assuming the requestor is a person, the person would typically access through a report viewer such as Adobe Acrobat. Another less preferable option is to return the report document in-line, within the same web-browser that the requestor uses for their primary session. As shown in FIG. 2 and in terms of the discussion that follows, the primary 20 and viewing sessions 29 are disassociated and managed separately.

Upon receipt of a report object, a viewer must be opened if one is not already open. The report viewer session can be local to the device (e.g. load a copy of Adobe Acrobat from the hard drive) or web-based (e.g. log on to MS Report Manager configured on the web-server). The view session 29 handles the report object and renders the report in the client [symbol] s report viewer. Concurrently, the primary session returns control back to the requestor [symbol] s idle in-session state 21 awaiting the next command request.

Disassociating primary and viewing sessions allows the requestor to log out of a primary session 23 and still continue report review activities. Alternatively, the requester could continue their primary session by electing to edit 22 or generate an additional client scenario 24. Each completed scenario generates a new report or document 28. Additional report objects add to the viewer [symbol] s report stack 29. The requestor decides which report to view, persist, or delete using the viewer [symbol] s command.

Domain Hierarchy and Architecture

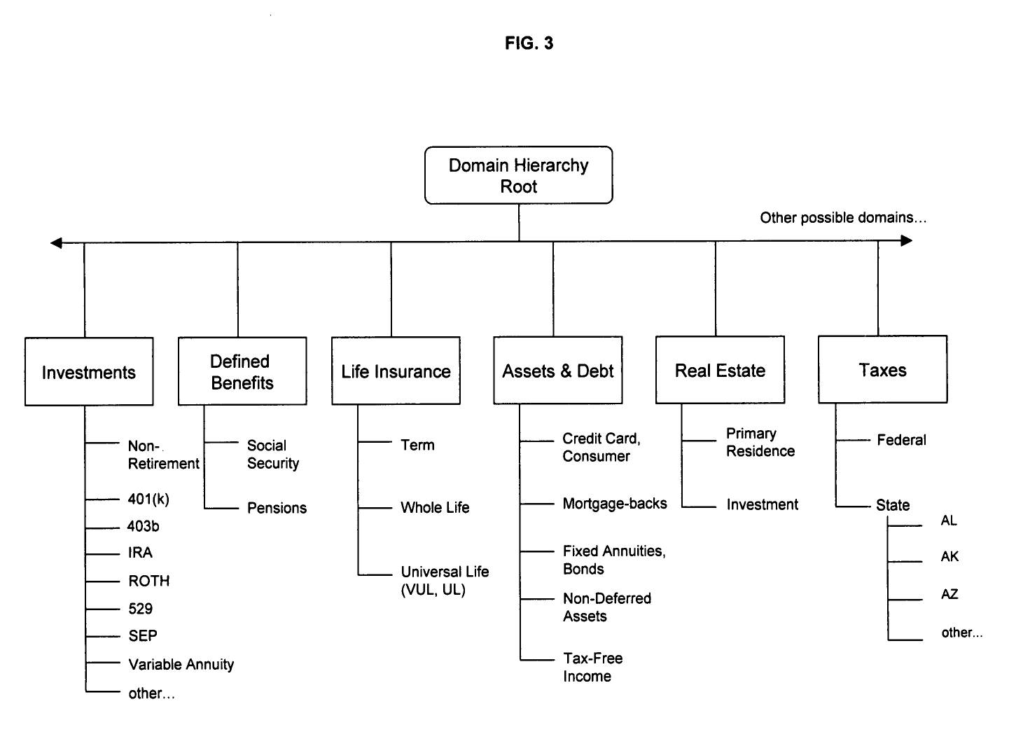

FIG. 3 illustrates a hierarchical tree structure, with labels that specifically describe a financial domain. The use of hierarchical trees is pervasive and pertinent throughout this invention. Included are the formal client and strategy hierarchies, both of which refer to and rely upon the financial domain hierarchy.

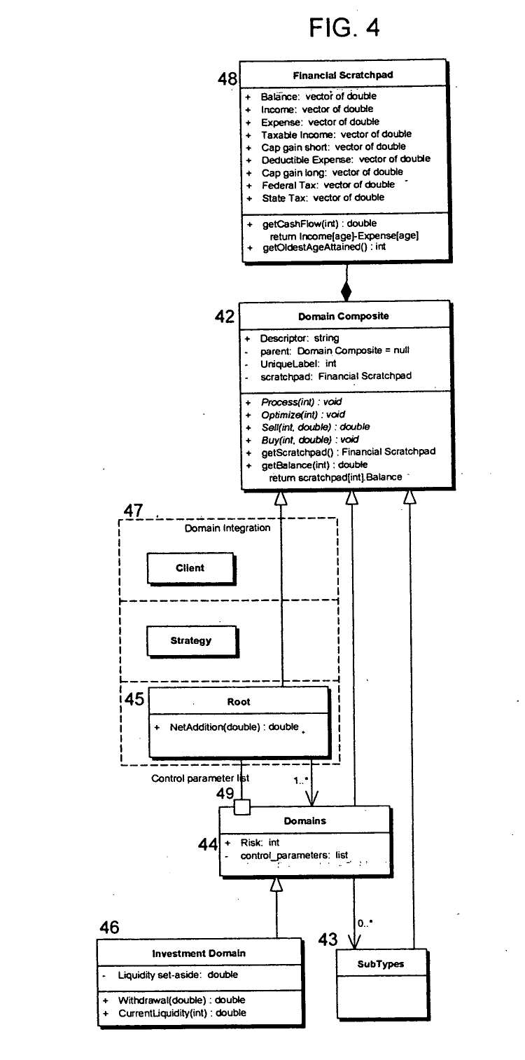

FIG. 4 is a formal architectural view of a financial domain. Each item in FIG. 3 is classed or generally characterized as a financial domain composite 42. All composites possess certain, similar properties. A property is a data attribute or a method. Attributes are always represented by data and may refer to scalars, variables, vectors, arrays, structures, and objects. Vectors are used to represent values across a client [symbol] s time dimension, such as a client [symbol] s net worth from their current age to their estimated mortality age. Methods are represented by logical constructs.

One financial domain composite attribute is known as the financial scratchpad 48, a container (including several vectors) that temporarily stores processed results, rewritten for every financial case run. A financial case run is one case of future volatility against a strategy. One client scenario may have hundreds or thousands of case runs. Other composite domain attributes include descriptors, relationship with its parent, and a unique label. Domain composite types are: (1) the sub-type 43, (2) the domain type 44, which may contain multiple sub-types, and a root 45. All domain composites have one and only one parent, except for the root which has no parent but is contained or owned by [symbol] domain integration [symbol] block 47. All domain composites have certain public methods 42. A public method is one that is accessible by an external process, such as the domain integration block 47. Public methods may be concrete (i.e. pre-specified) or abstract (i.e. non-specified). For example, the domain [symbol] s method [symbol] get the balance [symbol] is concrete in that this method is pre-specified, i.e.—the same method is iterated across all its children to calculate a domain [symbol] s entire balance.

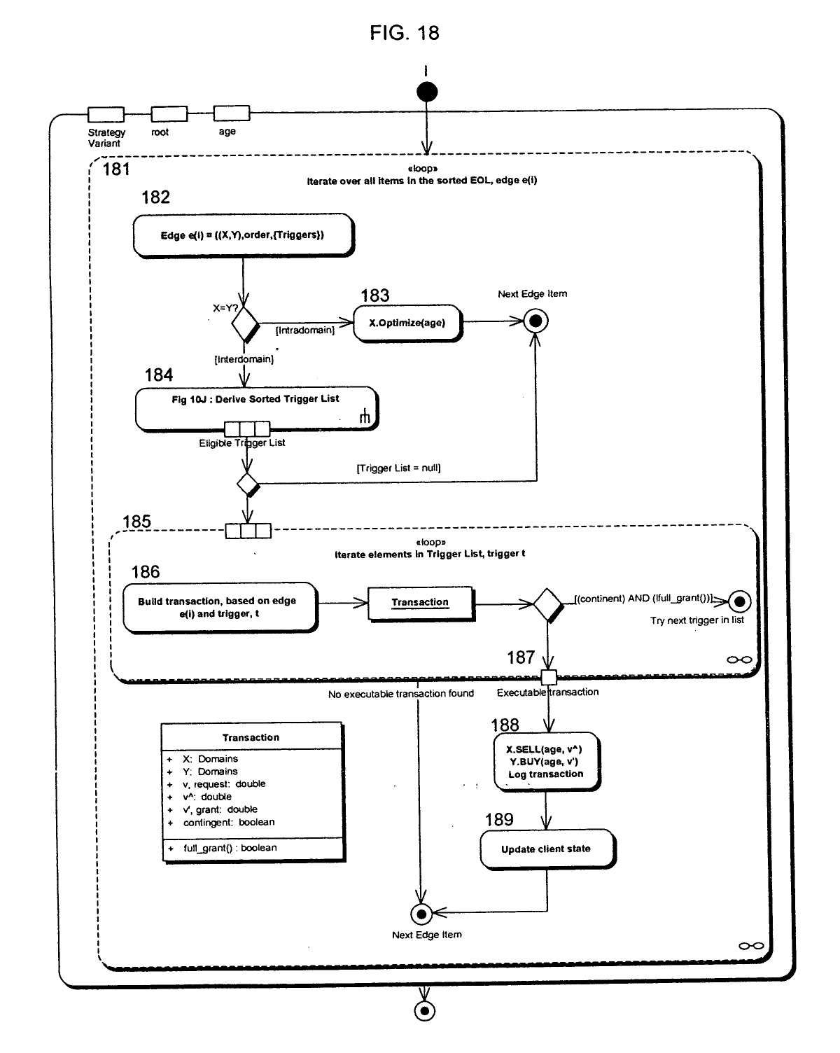

Abstract methods require further specification or alteration to be executable. Key abstract domain composite methods are: buy; sell; net cash flow; process; optimize. [symbol] Buy [symbol] means to buy into (i.e. add value to) a domain. [symbol] Sell [symbol] means to extract value from a domain. Buying and selling is a method used to exchange value from one financial domain to another through strategy transactions, a process to be described as part [symbol] Strategy Execution [symbol] , FIG. 18.

A detailed description of the methods used in each domain is not necessary to describe the invention's architecture. However, one example is included to make the discussion of architecture better understood. The example refers to methods of the Investment domain 46. Domains may have extra-methods or functionality, as a specific domain requires or as a domain author sees fit, beyond base methods that all domain composites have. A domain author is an expert in a specific financial domain, who may not necessarily be the implementers of this invention, but who provide the details for financial domain methods. In this discussion, the Investment domain 46 is extended to include extra-method called [symbol] Withdrawal [symbol] .

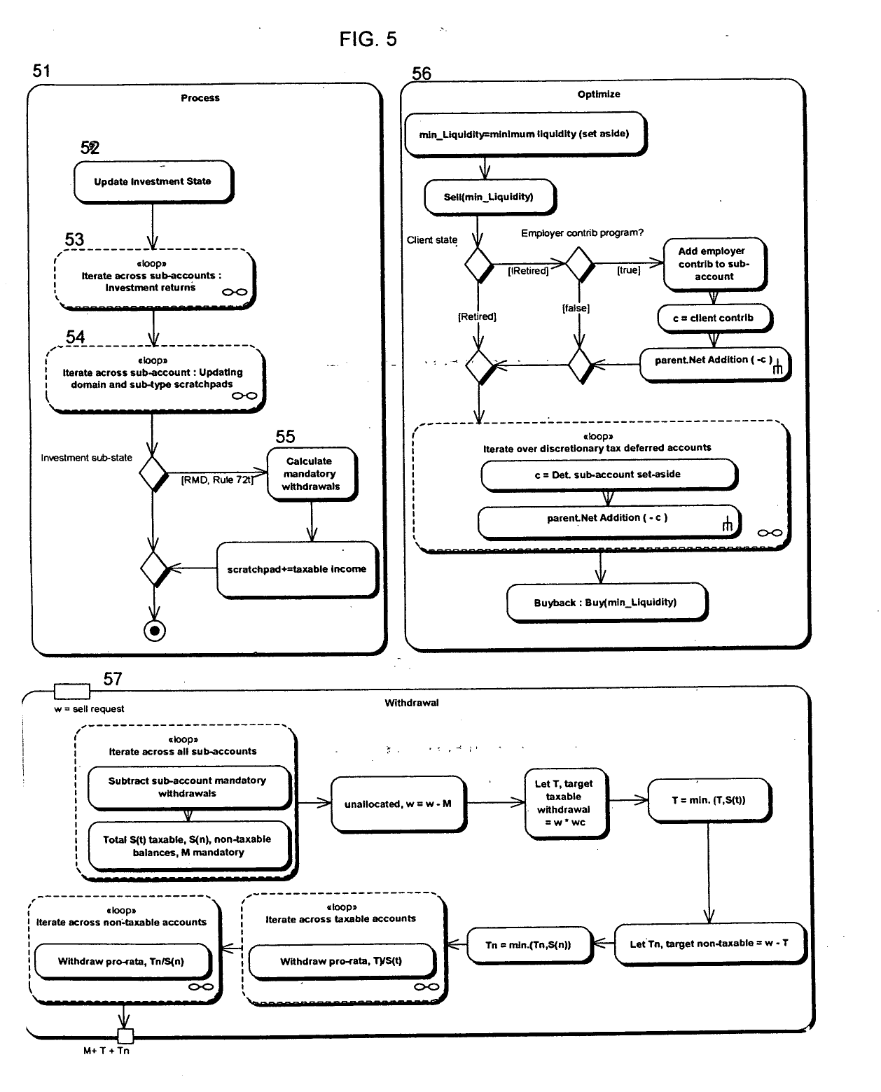

For the purpose of this example, assume the root domain initiates each “process” for each of its child domains. Each child domain performs its unique [symbol] process [symbol] Depending on the domain [symbol] s internal process, the domain may then call up its sub-types to [symbol] process [symbol] FIG. 5 illustrates the investment domain [symbol] s process 51. As part of [symbol] process [symbol] , a domain may define and first undergo its own state change 52. For example, one investment state relates to whether investment withdrawals are [symbol] mandatory [symbol] from qualified investment accounts. Entering the mandatory state forcibly requires a minimum level of income to be drawn out of certain tax-deferred investment accounts, such as an IRA.

Output from a [symbol] process [symbol] requires that the domain updates the data elements within its domain financial scratchpad. A domain [symbol] s process can be simple or complex. In the investment domain, assume a domain author uses Monte Carlo (MCS) simulation 53 as the basis for updating the investment scratchpad. The Investment domain author has latitude to use MCS for the entire domain or selected sub-types. In the latter case, the domain process would build sub-type scratchpads and the domain would aggregate across all of its sub-type scratchpads to derive the Investment domain scratchpad 54. To complete the Investment domain process, mandatory withdrawals may be required 55. The output of [symbol] process [symbol] must be an accurate scratchpad update for the domain regardless of the internal methods the domain author chooses.

The method called [symbol] optimize [symbol] represents buy-sell activity within a domain, possibly affecting distribution of resources across domain [symbol] s sub-types. In the case of the Investment domain, this might include the allocation across different sub-types (e.g. investment account types shown in FIG. 3: 401 (k), 403(b), IRA, ROTH, etc.). An allocation rule may be based on heuristics to fund employer sponsored retirement accounts, discretionary retirement accounts, or to convert IRA-to-Roth types. Example logic for this method is illustrated in block 56.

The extra method of [symbol] withdrawal [symbol] 46 for the Investment domain is also described 57. This method accepts one input as a requested withdrawal amount.

The algorithm also uses a parameter called the [symbol] withdrawal coefficient [symbol] to differentiate withdrawals between tax deferred and non-deferred sub-accounts. The withdrawal coefficient is part of a set of control parameters 49 for the Investment domain. Control parameters exist for all domains. They provide a means by which the behavior of a domain method can be altered by any process that consumes the domain model. A domain author defines a set of parameter controls and provides a means by which a process can identify which controls the domain author makes available for use by external processes. One control parameter that all financial domains should define and provide access to is [symbol] risk [symbol] , a client attitude characterized as conservative, moderate, aggressive, conservative-moderate, moderate-aggressive). How a domain author chooses to use any control parameter in a method is up to the domain author.

The italicized composite methods in block 42 are [symbol] abstract [symbol] , including the examples described above. The notion of abstract methods allows the acceptance of intelligence from domain sub-type specific subject matter experts. Their intelligence must be expressed before a domain model can be executed. The format of this intelligence can be statically recorded in hard code or dynamically coded for [symbol] just in time [symbol] domain processing.

Other domains may be expected to utilize widely different methods to implement their respective domain composite abstract methods. For example, federal and state tax domains are a special type. As cash flow [symbol] drainers [symbol] , they are the only domains privileged to affect their respective [symbol] tax [symbol] vectors specified in a financial scratchpad. The debt/asset domain might substantially affect a scratchpad [symbol] s balance, income, and expense vectors. The methods of the insurance domain might consider a client [symbol] s specified health status, whereas the methods of an investment domain might not care. The modeling techniques for treating and diagnosing domain sub-type interdependencies in a consistent and holistic manner is central to the invention [symbol] s strategic planning architecture.

Client Description

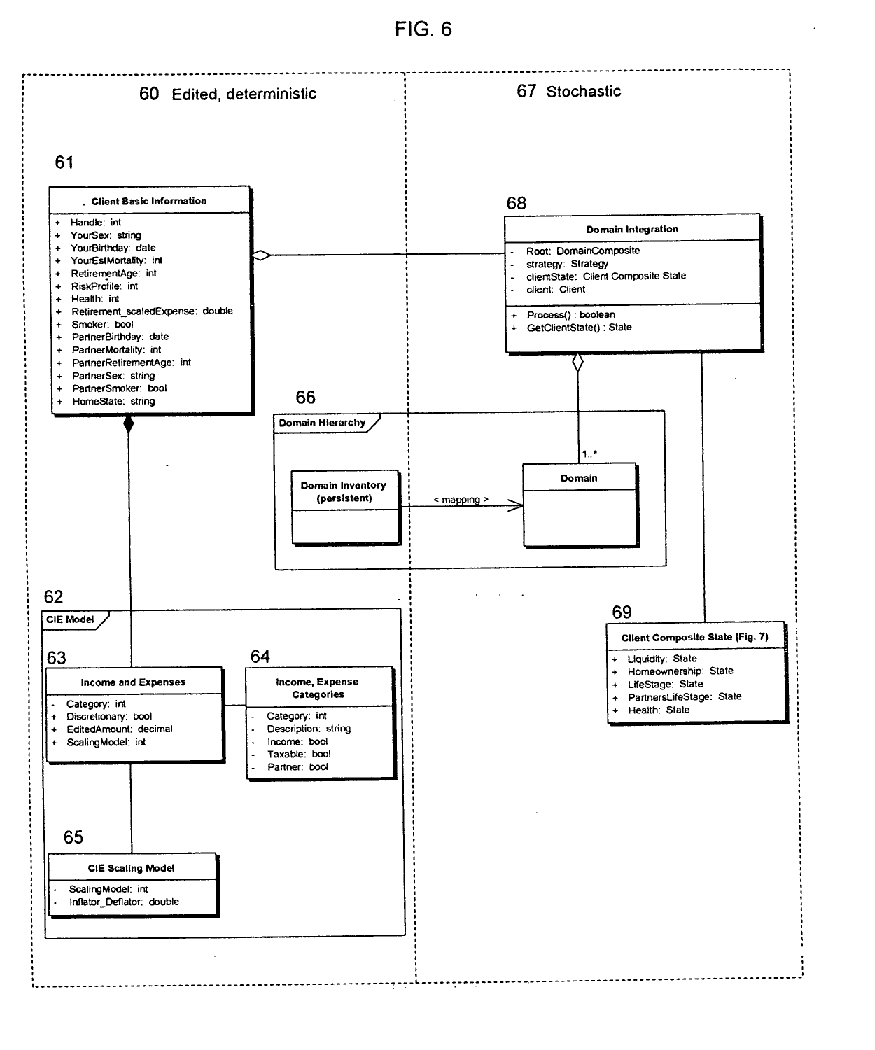

Henceforth, the term [symbol] client [symbol] means specifically the person that is the object of a planning scenario. A client is described formally in FIG. 6 which is divided into two vertical partitions: (1) the editable client description, the left or deterministic vertical 60, and (2) the non-editable client description, the right or stochastic vertical 67. The deterministic vertical suggests that derived values are calculable with a degree of certainty or near-certainty in either future or present value terms, when the discount or inflation factor is known. The stochastic vertical suggests that values are subject to uncertainty based on random or chaotic behavior that cannot be exactly predicted.

The editable client description contains three classes: (1) client basic information 61, (2) client income and expenses (CIE) 62; and (3) domain inventory (i.e. the entire set of editable domain items that can be mapped to the domain hierarchy) 56.

A client's basic information 61 is structurally flat. It contains scalars of various attribute types known or approximated by the client (e.g. date-of-birth, sex, desired retirement age, projected mortality, information about partner or spouse, location information).

Client income and expense (CIE) 62 has three components: (1) an editable income and expense array where client express their amounts for: (a) each income/expense (IE) category, (b) further subdivided into essential versus discretionary, and (c) a choice of a scaling model to be applied consistent with client expectations of year-to-year change; (2) a primed, non-editable set of category definitions and properties 64; and (3) a primed, non-editable set of scaling models 65. Scaling models might include relative percentage increases or decreases, either in absolute terms or relative to inflation.

Clients express their domain inventory by specifying domain items, which are represented as data. Each domain item maps to one and only one specific domain sub-type. Clients specify items through domain editors designed specifically for a financial domain. In a preferred embodiment, a domain editor is accessed through a menu organization similar to FIG. 3. In another embodiment, domain items may be submitted by an external system (machine client) in the form of an XML data document. Each sub-type may contain a collection of items, which may be viewable in an editable grid format. A domain editor would typically present field edits appropriate for the chosen financial domain's sub-type. Domain editors include generic controls to add, delete, or modify data records. The client's handle, edited domain sub-type, and unique description for each edited item make up a unique data base key.

Certain data fields of a client's domain item may be non-editable. For example, a client may edit investments associated with their 401(k) retirement account. Each investment may be represented by stock ticker symbol (e.g. GOOG), a unique identifier. The stock symbol is a unique key to retrieve the current stock price. The information is retrievable externally through an Internet SOAP request. Of the three client description components, a client's domain inventory is probably the most dynamic; a client's basic information is typically the most static.

FIG. 6's right hand or stochastic vertical 67 includes two components accessible through the domain integration block 68: (1) the root and (2) client composite state, both of which are reinitialized and recalculated during each financial case run.

A client's income and expense items (IE) must be reflected in either, but not both, the deterministic or stochastic vertical. IE categories under a client's direct control are visible in a client editor. Examples are food, travel, and gifting. By contrast, IE categories exposed to future uncertainty are contained and modeled by a domain. For example, the stochastic modeling of future debt payments associated with an adjustable rate mortgage (ARM) is non-deterministic and is assigned to an expert domain model that factors variables such as interest rate volatility and inflation. As a guiding principle, the invention does not ask the customer to guess at values for which they have no expertise.

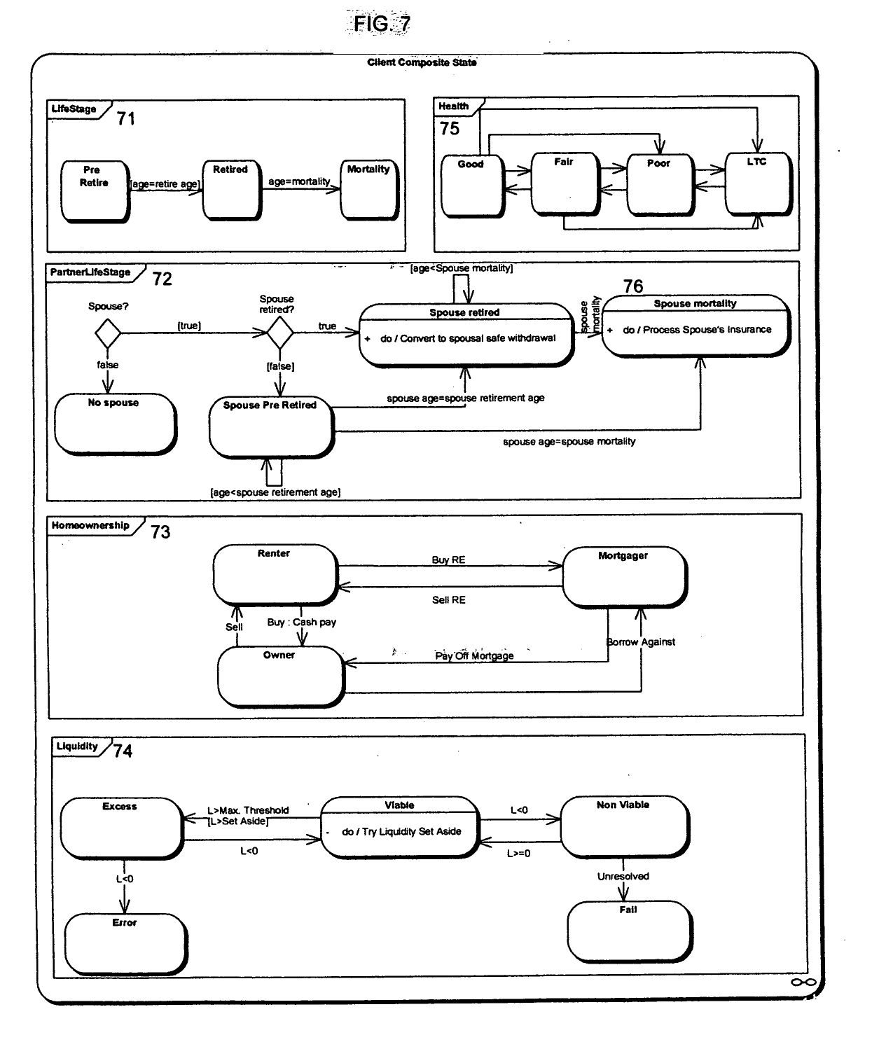

A client's composite state is a stochastic component 69. The client composite state as illustrated in FIG. 7, consists of 5 sub-states, including: (1) Life Stage, whether pre-retired, retired or reached mortality 71; (2) Partner's Life state 72, (3) Homeownership status 73, (4) Liquidity sub-state 74, signifying a client's ability to pay expenses on demand, and (5) Health sub-state 75. For each sub-state, transitions (life changes) move the client from one state to another. Some transitions are deterministic such as a client's age. Other transitions are stochastic, such as the likelihood of a change in a health status useful to model actuarial hazard functions such as risk associated with long term care.

Some state changes invoke other processes. For example, if the Partner's Life Stage transitions to mortality 76, a process associated with a spousal insurance assesses whether the client receives a life insurance payment. A client's composite state is also monitored by other methods and strategies during a process run.

Financial Strategy Architecture

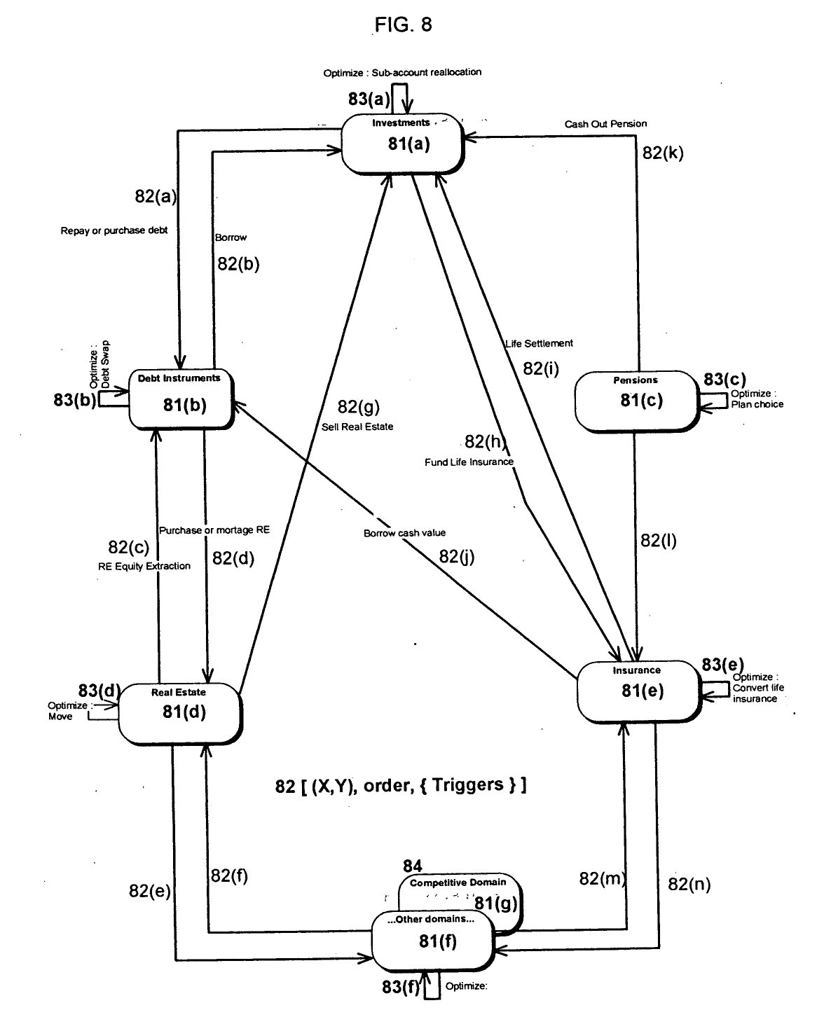

FIG. 8 is a graphical view of a financial strategy and two of four of its major components. Graph nodes represent a plurality of financial domains 81(a)-81(g). A financial domain's inclusion means that a domain is within the scope (i.e. “in-scope”) of a financial strategy. Its exclusion means that the domain is ignored by the strategy. If a client has a financial interest in a domain that is not in-scope, the financial strategy is too “weak”. A plurality of unidirectional edges 82(a)-82(n) connect domains, notated by (X,Y) where domain-X is the source and Y is the target domain. Edges represent a strategy's potential to exchange or “tradeoff” value from one domain to another through “selling” of one (e.g. X) and the “buying” of the other (e.g. Y). For example, the selling of Real Estate to generate cash for investment purposes is represented by an edge connecting the Real Estate domain to the Investment domain with the arrow pointing to the Investment domain. An edge's inclusion means the corresponding inter-domain tradeoff is “in-scope” as part of a financial strategy's decision space. Its exclusion means that decision is out-of-scope.

An edge has other attributes such as its order of evaluation (i.e. only one edge can be executed at a time from the full set of edges), and a set of triggers. Edges that point to both ends of a domain are “intra-domain” 83(a)-83(f) and signify internal domain “optimization”. Intra-domain edges are always included for in-scope domains, having no triggers by default and therefore execute unconditionally. Finally, a strategy may define competitive domains 84, where two separate domains exist for the same financial domain in an embodiment of this invention. For example, one tax domain might represent current tax code while the one might represent future tax code. In addition to being part of a formal architectural specification, FIG. 8 is a visual tool to communicate with clients about what domains and types of decision possibilities are contained in a strategy.

While graphs define the in-scope domains and decisions, an executable strategy requires other components and specification. The term strategy “variant” means a similar graphical form, but connotes a difference in the order in which edges are evaluated and the set of edge triggers. The construct that defines the order of edge evaluation is called the edge order list (EOL). A single fixed order would imply that edges at the list's head-end would receive priority. Since an edge defines an exchange of value from source to target domain, a fixed order creates bias. A process is needed to create a set of orthogonal, mutually independent edge lists to create different strategy variants. These variants are compared within an experimental framework, to be later described, to evaluate significance of decision order or priority.

The edge order list creator in block 90 provides the flow logic to create four variants for each strategy graph. These lists define the order or priority in which edges are evaluated. A numerical input parameter, known as “variant”, modifies the algorithm to yield a different order for the edge order list. The numerical variant maps into two toggles, known as “inverse” and “absolute difference”. From an empty list, the process is to first build the unsorted list 91. The process iterates over all in-scope edges for a given financial strategy.

For each edge (X,Y), an arithmetic weight difference w_{x,y} is defined as wₓ−w_{y-1} where w might be a client's “sum absolute present value” in a financial domain, i.e. the summation of the absolute present value of all the domain items belonging to a domain.

The input parameters function as follows in block 92: (1) when “absolute difference” is toggled, the weight is calculated as the absolute value of the arithmetic weight difference, and (2) if “inverse” is toggled, the result from (1) is signed inverted (i.e. multiplied by negative 1). A tuple (e.g. [(X,Y), w_{xy}, wₓ,X]) is created and added to an unsorted tuple-list 93. Once the complete unsorted edge list is built, the list is sorted according to descending weights w_{xy} 94. The tuple's third and fourth terms serve as tie-breakers to prevent sort ambiguity.

“Inverse” inverts a list. For example, assume the order of edge evaluation when “inverse” is not toggled is {(i,j), (i,k), (j,k), (k,j), (k,i), (j,i)} where i, j, k are 3 domains. “inverse” creates {(j,i), (k,i), (k,j), (i,k), (i,k), (i,j)}.

To understand the effect of “absolute difference”, the example is extended to include the intra-domain edges (i,i), (i,j), (k,k). When “absolute difference” is not toggled and not inverted, the sorted list will place the edges connecting domains with the highest weight difference at the top-of-list. If edge (i,j) had the greatest positive weight difference, edge (i,j) would be top-of-list. Edge (j,i) would appear at the list-end, since its weight difference is the highest negative value. Intra-domain edges would be grouped in the center of the list, since all intra-domain weight differences are zero. Their specific order would depend on tie-breakers. The sorted list might be look like {(i,j), (j,k), (k,i), (i,i), (j,j), (k,k), (i,k), (k,j), (j,i)}. All other factors being equal, this scheme suggests increased financial diversification among the domains, since the priority favors the evaluation of tradeoffs from a client's heavily weighted domains to low weighted domains.

When “Absolute Difference” is toggled, any inter-domain edge where wᵢⱼ>0 ranks higher than any intra-domain edge. All intra-domain edges, as a group, would appear at the list bottom. The following pattern might be the result from the case above {(i,j), (j,i), (j,k), (k,j), (k,i), (i,k), (i,i), (j,j), (k,k)}. This pattern would tend towards concentrating a client's value in certain domains. The toggling of both “inverse” and “Absolute Difference” would place the intra-domain edges ahead of the inter-domain edges.

The four lists provide strategy variants that alter decision priorities thereby widening possible client decision paths, and provide competition among the variants. Four such lists are both necessary and sufficient to attain domain neutrality, and provide comparisons of diversification and concentration strategies.

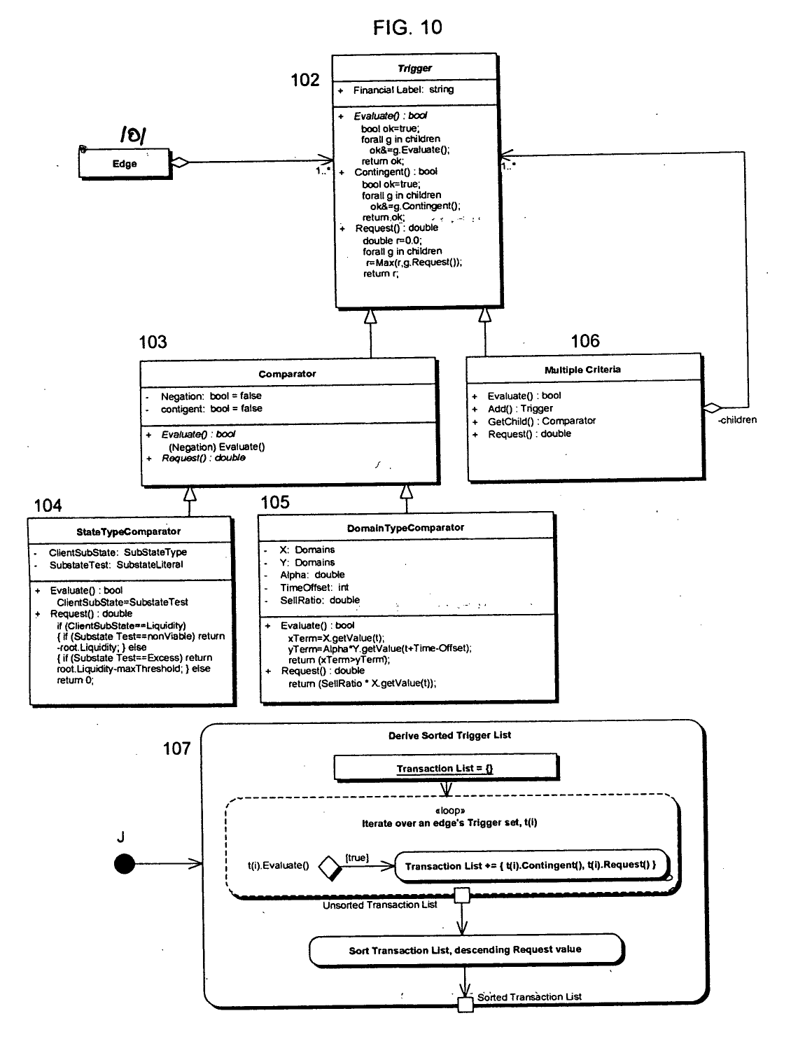

A strategy also includes a component known as edge triggers. An edge may have a collection of triggers 101. Each trigger is labeled to conform to a common financial transaction meaning. A trigger specifies a set of conditions that controls whether an edge “fires”, resulting in an executable transaction between two domains. A trigger is defined by a formal trigger specification in FIG. 10. The specification allows a trigger to be a simple or a complex comparator or expression. A complex trigger is modeled by a class composite structure. A trigger may be multi-criteria, where each component's condition must be satisfied for a trigger to fire 102. The trigger specification also defines default value for the transaction, as a function of the trigger comparator type, and whether a transaction is contingent on the potential realized value if the corresponding transaction were to be executed.

An example of a trigger is the non-viable liquidity state 74. By definition, an unresolved liquidity state will result in a failed case run scenario. Hence, during the case run process, a strategy will make a diligent effort to resolve a non-viable state. A trigger so defined (i.e. to prevent case run failure) is called “primary”. The default transaction value of the non-viable liquidity trigger is an amount necessary to resolve the non-viable liquidity state. Non-primary triggers are discretionary. For example, a non-primary trigger is the liquidity sub-state defined as “excess”. Triggers are not limited to liquidity sub-state; they may involve other client sub-states, such as the client's Life Stage.

Two types of trigger comparators 103 exist: (1) a client sub-state 104, as in the liquidity example above, and (2) a domain comparator 105. A domain comparator 105 is expressed in terms of the arithmetic operators, such as greater than (e.g. >). The operands relate to X,Y financial scratchpad vector entries at a designated time instance, a single age in a process where age is being iterated cross a client's time dimension. For example, the following can be expressed by a domain comparator. Assume t to be the current time instance. A trigger example: Edge (Real Estate, Investment).Trigger=(Net worth (Real Estate (t))>α×(Balance (Investment(t+τ))), defines an edge connecting Real Estate to Investments that will fire if a retired client's present real estate net worth (i.e. t) is “expected” to exceed α×the client's anticipated investment (t+τ, where τ>0, where α>1). A decision will cause the client to sell real estate in the current year if their real estate value is expected to exceed their investment portfolio τ years from now. The parameters τ and α must be concrete for the strategy to be executable.

If the above evaluation rule were to be limited to a retired client, the trigger would need to be defined as multi-criteria composite 106 that would contain both a domain comparator, such as the one stated above, and a client sub-state comparator (e.g. Life Stage=Retired). By definition, multi-criteria means that all contained trigger components must evaluate as “true”. Further, if any of the multi-criteria contained components are contingent, then the multi-criteria composite is contingent. Also, the transaction value of the composite is the maximum value of component transaction values.

A time-offset controls a trigger's style (i.e. passive, aggressive). Strategic planning distinguishes itself from tactical planning by two style methods: (1) contingent deferred decisions (i.e. “wait-and-see”) are passive using “lag” offsets, whereas (2) a proactive trigger uses “lead” offsets. One well-known financial problem solved using a proactive trigger is the application of permanent life insurance prior to manifest need to optimize long-term income streams, sometimes referred to as “pension maximization”. This proactive style avoids the regret “if I knew then what I know now, I would have done things differently”.

A proactive trigger cannot be allowed to “cheat”. The method “cheats” when it has absolute full “deterministic knowledge” of an uncertain, future stochastic event. However, a trigger does not cheat if it relies on expected properties of a stochastic distribution. As an example, you can assume the roll of two dice is expected to average 7 over the long-run, but you cannot predict an exact sequence of dice rolls. The same applies to decisions based on future investment returns, interest rates, etc.

Whereas primary triggers are designed to avoid case run failure, “discretionary” triggers are an attempt by a financial strategist to improve a client's future end-state by performing domain transfers from “unfriendly” to “friendly” domains. Triggers may be based on: (1) deterministic improvements (i.e. calculable with certainty; optimized), (2) heuristic method(s) thought to, but not guaranteed to improve a client's long-term state, or (3) any other reasoning at the discretion of a strategist that might result in a “good” or “poor” strategy.

The complete specification of edges and triggers, in a formal hierarchical framework, defines a financial strategy. Financial strategists provide the concrete specification for the edges and triggers. Financial strategies may offer competing strategies, express them through the formal specifications above, and offer them either statically (“hard coded”) or dynamically (e.g. eCommerce exchange).

Execution of a Client Scenario

Having described domains, client, and strategic architectures and their respective components, the scenario processor, as presented in FIG. 11, is the general logic which controls the process and optimization of a client's scenario in block 55. The scenario processor receives the client object containing the input client description, finds a grossly feasible retirement plan solution assuming one exists, optionally finds a “local minimum” solution, and finally creates scenario output 56.

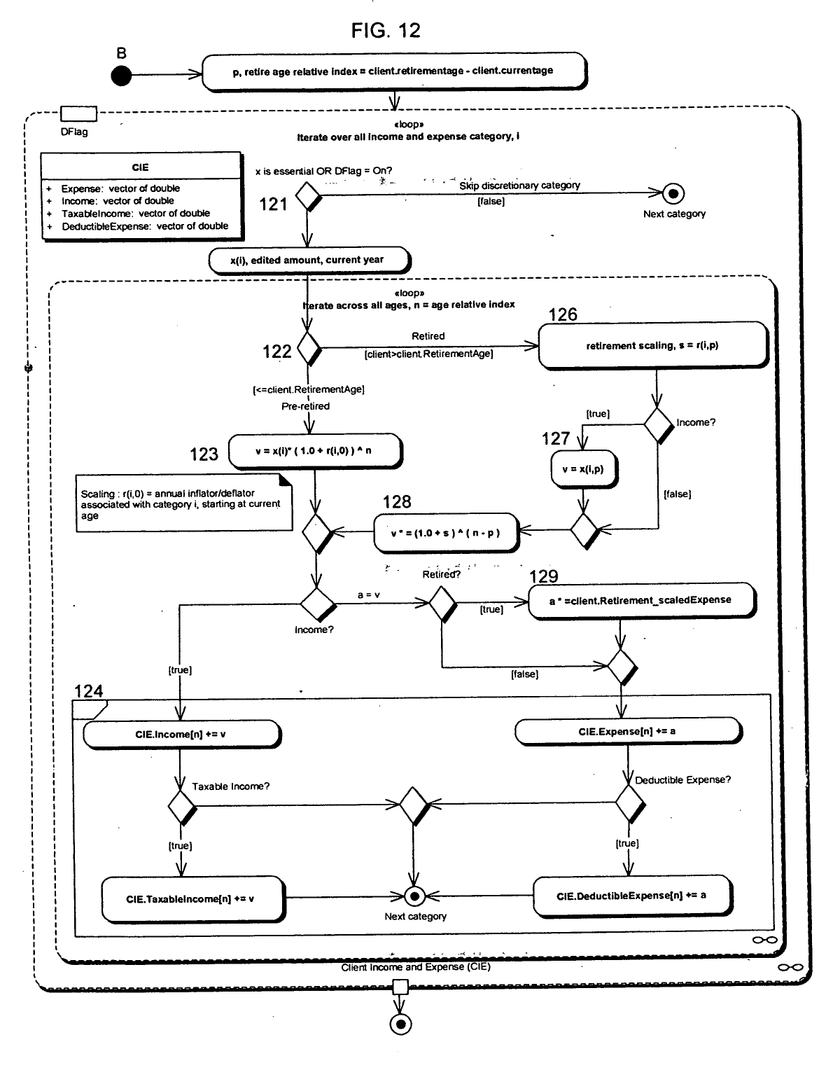

Upon initial entry of the scenario process, a Boolean flag known as the discretionary flag “dFlag” is enabled. The client's retirement preference is set to their first preference. An object known as the CIE, a container with some structural similarity to the scratchpad, is created. The CIE incorporates the calculations of the client input description 111. CIE calculations are described in FIG. 12. The algorithm iterates across all CIE defined deterministic income and expense categories and, within each category, across the client's time dimension, the time span from client's current age to expected mortality age. Only if a category is deemed essential or the dFlag is on, will the category be included in the calculation 121. A comparison is made to determine whether the age represents client pre- or post-retirement 122. If pre-retired, a value “v” is computed based on client edit “x(i)” for the category and scaled according to the inflator/deflator choice “r(i)” and raised to the power based on the age relative index “n” 123. The value will be added to the appropriate CIE items 124. If retired, post-retirement scaling replaces pre-retirement scaling factor, as the post-retirement scale as specified by client editing 126 or possibly by the default scaling from an expert system. If a post-retirement income category, the income value is also replaced 127 as specified by client post-retirement editing. The post-retirement expense value is not replaced, but assumes the value just prior to retirement age and how that may have been derived from pre-retirement scaling. Results are then scaled 128. Finally, the values are added to the CIE as described earlier 124, except expenses are adjusted according to the client's post-retirement aggregate lifetime scaling factor 129. The category and age control loops continue until termination to fully complete the CIE vectors.

A pre-trial run 112 is performed using the financial case run process to be later described. The trial is based on average expectations of the future (i.e. without induced volatility) also known as a “linear case scenario”. The first time through the control loop 110, the trial is based on the client primary retirement preference, as edited in client's basic information. The result of a trial run is an assessment on a client's gross feasibility assuming the use of a baseline strategy against the linear case scenario. If a trial run concludes a solution is grossly feasible, the scenario process will continue to the next stage 113. If not gross feasible, the discretionary flag is turned off for the duration of the scenario process and a “next client retirement preference” is attempted. “Next preferential” choices may be a simple construct, such as reduced post-retirement standard-of-living, a set of retirement ages that postpones retirement age, or some combination thereof.

Collectively, this process just described is known as the gross feasibility adjuster in block 110, which is designed to complete an informative scenario run for the client, although the result may not reflect the client's first preferential choice.

Each cycling through the gross feasibility adjuster causes the CIE to be recomputed 111. A reduced preference may result in gross feasibility at some preference level or it may not even exist even after all possible preferences have been tested. Should a gross feasibility not be found, the entire scenario is marked as a failure and the scenario generation process terminates.

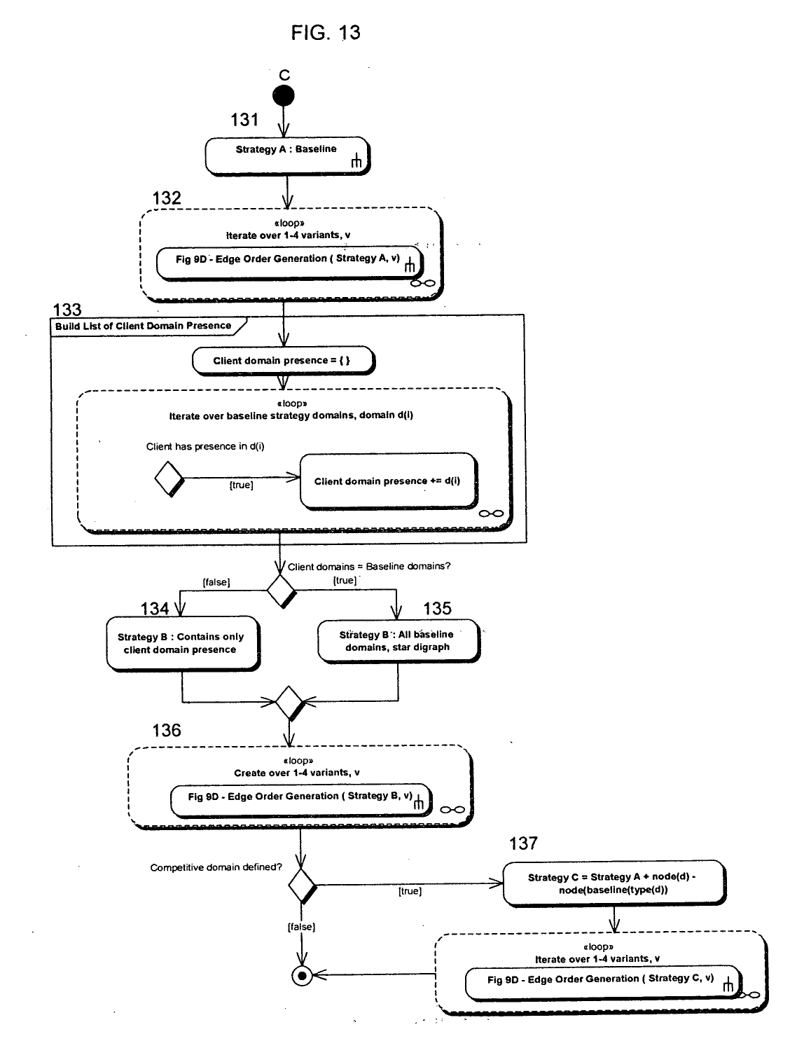

Assuming one of the preferential choices is deemed feasible, the next process is to generate a minimum of two abstract, dissimilar strategies and their four edge order list variants for this scenario in block 113. Two strategies are dissimilar if they have a different graph appearance, i.e.—dissimilarity in domain or edge inclusion. Depicted in FIG. 13, the strategy creator starts with the creation of Strategy A 131, defined as all domains and edges in an embodiment of this invention. This complete domain and edge set for an embodiment is known as the “baseline”. The four edge order list variants for this strategy are then pre-built for later execution. The list variants are static once a financial strategy is known in its graphical form. The edge order list generation method is called four times for each graphical strategy passing a different numerical variant parameter, ranging 1 to 4 in block 132.

A generally useful alternative to strategy A is a subset of the baseline. The method builds a list of domains that includes only those where the client has a current financial interest 133. If this resulting set is a subset of the complete baseline set, strategy B is defined as the subset 134. For example, if a client has no life insurance, the B strategy would not include the life insurance domain. The sparser B strategy might have merit in terms of offering clients a very simple decision path, maintaining a presence only in those domains already familiar to the client.

If a client has current interest in all baseline domains, no single baseline domain would be unfamiliar to the client. A strategy B is then adjusted by keeping only those edges that create a star graph in block 135, where the only edges included are the ones that connect to the Investment domain, the domain presumed to be the prime source of client liquidity. The four edge order list variants related to strategy B are then pre-built in block 136.

A third strategy is possible, relating fundamentally to a scenario's or embodiment's purpose. This purpose may be used to compare the effect of a competitive domain 137, such as an alternate theory on investments, taxes, etc. The Strategy C option is the same as strategy A, except for the “competitive” domain difference. The four edge order list variants for strategy C are pre-built.

Three strategies are possible if two competing domains are defined in an embodiment. An embodiment is not limited in the strategies that it creates, as a financial strategist has the freedom to construct others. Thus, the output of the strategy creator is a set of “n” strategies 113, dimensioned by the number of strategies created and by the four edge order variants for each strategy.

Once all strategy variants have been created, the function of the hybrid experimental design framer (HEDF) in block 114 is to identify which strategy, variant, and parameter set have a substantive, global effect on client scenarios. HEDF creates an experimental framework, conducts the experiment (i.e. many financial case runs), and evaluates the results using formalized statistical approaches, such as common ANOVA (Analysis of Variance) and non-zero sum gaming. HEDF may be used twice during a client scenario, the first pass to determine an optimum coarse strategy (i.e. strategy, variant, parameter set) and an optional second pass to fine-tune the solution (i.e. specific strategy variant and fine parameter set).

First, the HEDF creates a multi-dimensional array, known as the HEDF array (HEDA). HEDA is a construct to record the output of many case runs 115. HEDA is initially defined as a 3-dimensional array, each dimension relates to experimental factors under ANOVA investigation. HEDF factors are always constrained to an enumerated set. For the first pass, the specific factors are the n×4 dimensions of strategy output object, as determined by the strategy creator, (1) n, the number of strategies, and (2) the four variants. The third experimental factor is “strategic risk”. Optimum risk is defined as the strategic risk level where client retirement success probability is the greatest. The enumerated set of risks includes the client's specified risk tolerance, as defined in client's basic information and one gradation on both sides. Consequently, the HEDA is initially constructed as an n×4×3 array.

Each HEDA element in the n×4×3 array is itself a “stack”, which might be considered a fourth dimension except it is outside ANOVA factor significance testing. The “stack” is a list container that holds individual results of a plurality of financial case runs. Results from each run are placed on the stack as each financial case run completes. The result might be a copy of the earlier referred to root's scratchpad or a summary derivation of, minimally the “oldest age attained” or net worth at “oldest age attained”. The stack size is dimensioned according to the minimum number (“m”) of cases stipulated as part of HEDF. Each case represents a different future, such as creation of a different interest rate environment, investment or housing market returns, etc. The stack allows ANOVA to perform various types of statistical analysis and evaluate factor significance (i.e. strategy, variant, risk) using multiple metrics (e.g. mean, variance, other moments of “oldest age attained” or net worth).

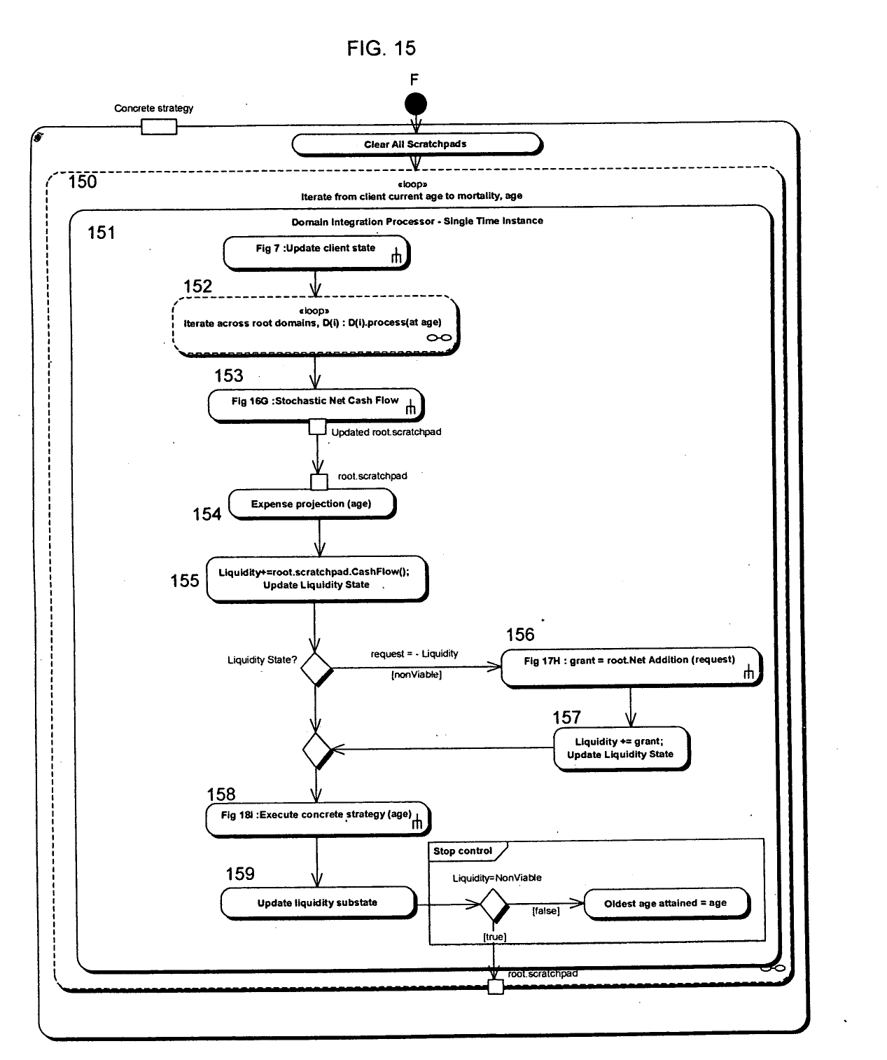

Each of the m-cases will have n×4×3 separate “financial case runs”, where “financial case run” is subsequently described by FIG. 15. HEDF's post process starts only when the experimental runs and the output HEDA have been completed. ANOVA can permute and test any two-factors or one-factor along the different HEDA dimensions. In determining the optimum coarse strategy, 3 separate 2-factor tests and 3 separate 1-factor tests are possible.

HEDF also utilizes non-zero sum gaming as a complement to ANOVA for assessing strategic risk. The output of the game is a fractionalized metric of optimum risk.

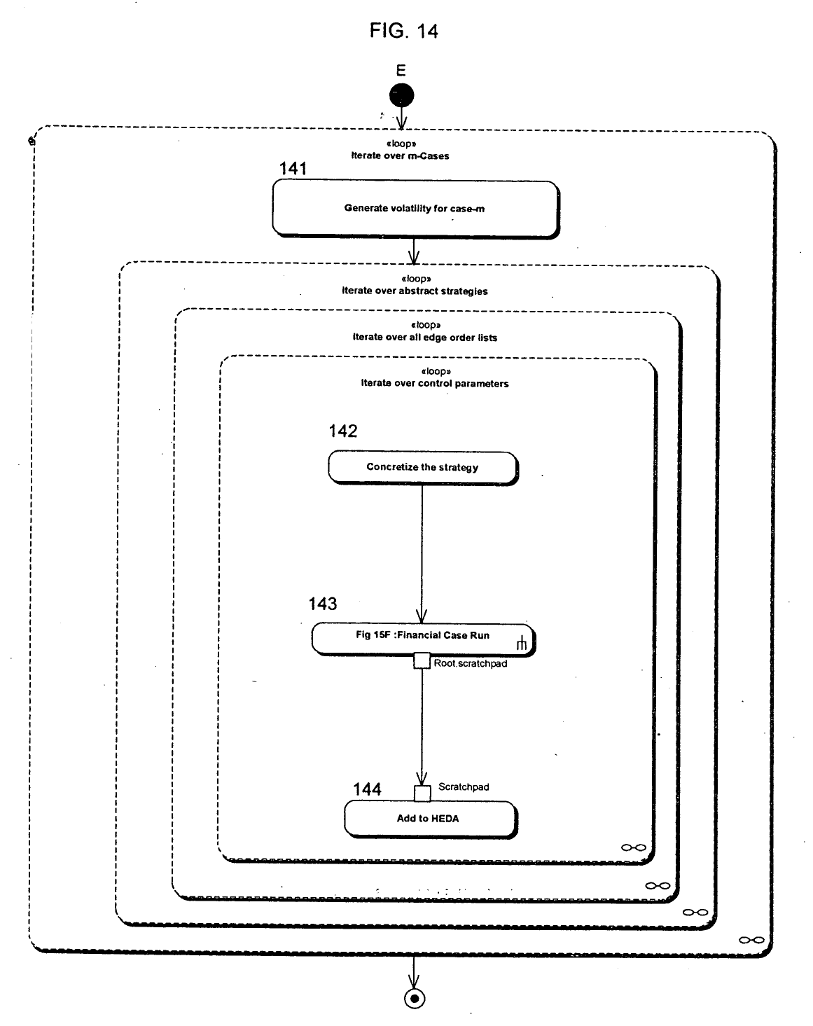

The experimental run depicted in FIG. 14 is a concentric series of iterative and process loops. The first loop is the case generator in block 141, whose purpose is to generate volatility for uncertainty variables (i.e. scalars, vectors) that may be common and visible to all domains. For example, the processing of debt, investment, and real estate may have dependency on an interest rate future. The same future uncertainty must be consistently communicated to each of the financial domains. Whether a domain makes use of an uncertainty variable is up to the domain's author and the methods the author uses.

Within the case loop, the inner loops iterate over the HEDF factors, such that each case is tested by n×4×3 different concrete strategies 142. Each of these tests is a “financial case run” in block 143. All scratchpads are reinitialized at the start of a run. The financial case run is a complex series processes to be described in FIG. 115. The output of a financial case run is a completed financial scratchpad up to the “oldest attained age”. Finally, the scratchpad is added to the appropriate “stack” pertaining to the HEDA element 144, the element index based on the strategy, variant, and enumerated risk factor corresponding to the run.

Once the experimental runs complete (i.e. m×n×4×3 financial case runs), the HEDA is now ready for ANOVA and gaming analysis. ANOVA completes HEDF 114 by permuting 1-factor and 2-factor tests in the array to identify a set of critical success factors (CSF) that includes a specific strategy, variant, and risk. Since a HEDA “stack” holds a collection of results, common statistical data reduction across the element stacks is required to allow ANOVA focus on one statistic at a time. For example, assume the desired metric for ANOVA was a success ratio. A data reduction would then sum the number of successful runs (e.g. “oldest age attained”=client mortality) divided by m. ANOVA might be extended to consider an alternative metric, such as a client's (net worth) balance.

An entire scenario is deemed “feasible” if a success ratio meets a certain minimum percentage threshold (i.e. if ratio>=threshold, such as 50%). A client scenario may be feasible if it is feasible for its CSF. Example: A client scenario would be considered to be CSF feasible if the percentage of feasible runs exceeds 60% if strategy B is part of CSF, even if strategy A were a “poor” strategy. A client should only be interested in a strategy that works (e.g. strategy B) and need not be confounded by the ones which do not meet a feasibility threshold.

The scenario may or may not pass the feasibility test just described. If a scenario is not feasible and a retry is permitted, a control loop exists to enable the gross feasibility adjuster in block 110 to re-evaluate other, lower client preferences. If other preferences still remain, the entire process recycles until such point that the control loop in the scenario process terminates. When other preferences are exhausted, the entire scenario fails.

The experimental run loop referred to a financial case run 143. A financial case run is defined as the use of a concrete strategy applied against a case. Detailed in FIG. 15, the financial case run can be thought of as a control process that includes a timing mechanism and integrates the workings of previously described architectural components. First is the timing element, the iteration across a client's time dimension in block 150. For each age until mortality or the “oldest age attained”, whichever is earlier, the domain integration processor in block 151 executes and coordinates the activities related to the client, concrete financial strategy, and domain's “root”.

The domain integration processor is called for each age of the client's time dimension. First, the client's state is updated. Accurate state information is required for other dependent processes. These dependent processes may be contained in either the domain integration processor itself or referred to by other objects, such as the concrete strategy. For example, the client may have transitioned from a state of pre-retirement to retirement. A client's partner may have entered a new state. A state change may spur a process, such as the “death of spouse that converts life insurance to liquidity” if a spouse has died with life insurance in force. A client's mortgage for their primary residence may have paid off transitioning them to an “owner” state. The client may have had a change in health status. Strategies (i.e. associated triggers) or domain processes may refer to these sub-states for their execution.

The domain integration requests the root to “process”. The root then invokes all financial domain processes for the current time instance 152. Financial domain “process” methods are unique, varied, and may be complex. The output of each domain process is the updated financial scratchpads associated with each domain and possibly its sub-types.

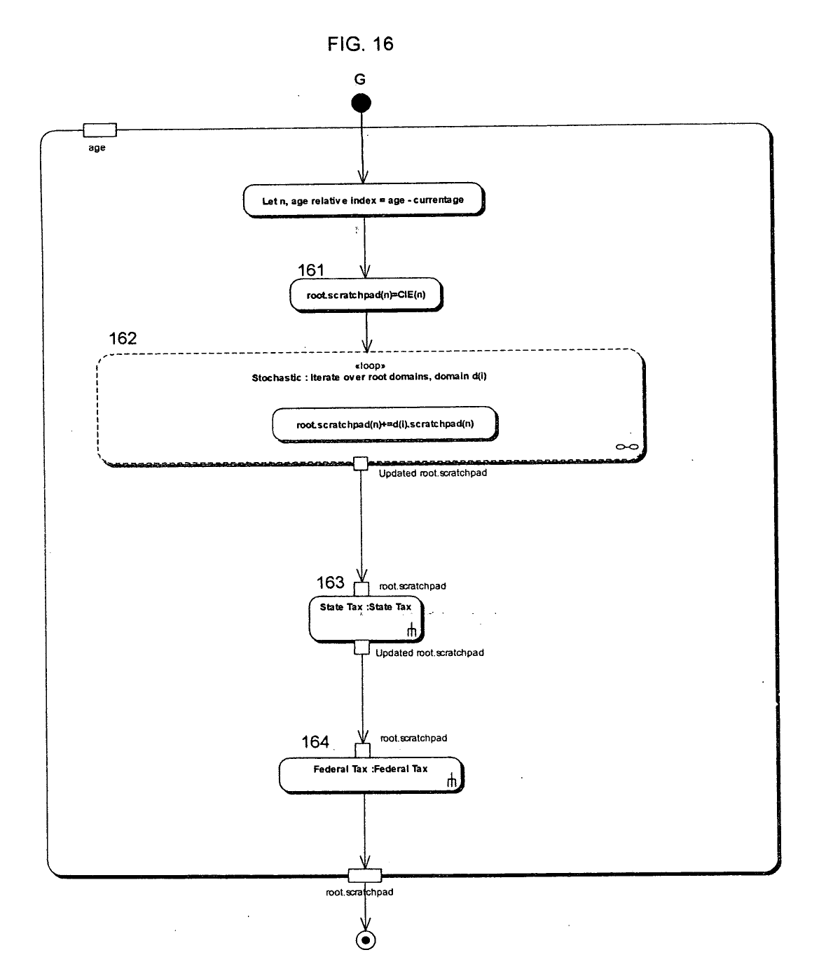

Next, a net cash flow calculation is determined 153 by the stochastic net cash flow calculator as described in FIG. 16. First, the root's scratchpad vector elements for this time instance is initialized by copying the corresponding data fields from the deterministic CIE 161. Secondly, the root scratchpad aggregates over all its contained financial domain scratchpads 162. Each scratchpad, in addition to calculating the net inflow or outflow (i.e. cash flow) for this time instance, also contains a full set of data elements needed for dependent processes, namely the state 163 and federal tax domains 164. The net cash flow calculation is dependent on CIE, domain, and tax domains in that precise order.

An expense projection, based on the root's scratchpad, is calculated 154. The expense projection is used as a basis for determining a client's liquidity ratio. The projection may be this year's expense or it may be a look-back or look-ahead alternative to eliminate single year expense anomalies. To determine current liquidity, the net cash flow in the time instance is added to a running liquidity tally (i.e. from the prior time instance) 155. The client's liquidity sub-state is updated. Liquidity sub-state transitions occur if: (a) liquidity falls below $0 (i.e. the client has insufficient liquidity to pay current expenses, a non-viable state that must be corrected) or (b) exceeds a maximum liquidity threshold, based on the ratio of current liquidity to the expense projection calculated above.

If the liquidity sub-state is non-viable, a liquidity shortfall is computed in the amount of the liquidity shortfall. This value represents a deficiency that is requested from the Investment domain. The net addition processor is asked to provide a full “grant”, based on a minimum “request” to resolve the shortfall. The grant, which may be less than the request, is then added to the current liquidity. The liquidity sub-state is re-evaluated. If the full request were granted, the liquidity sub-state will now have transitioned to the viable state as the shortfall request was determined based what was needed to close the liquidity gap.

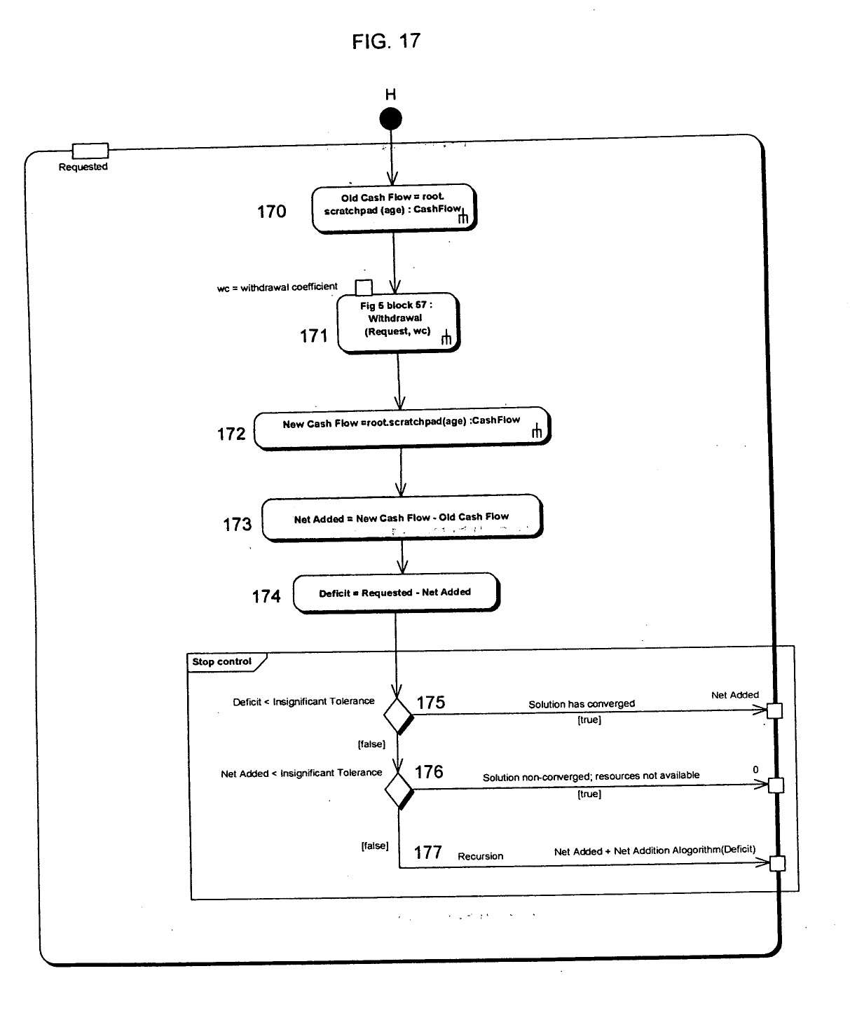

The net addition processor, as described in FIG. 17, attempts to fulfill the request through a tail recursive method. An attempt is made to fulfill the requirement incrementally by extracting only what is minimally needed to fill the remaining gap. Initially, this is the shortfall amount as described above. The net cash flow, as reflected in the root's current scratchpad, is stored as “old cash flow” 170. A request, interpreted as a gross withdrawal, is made of the Investment domain 171. Cash flow is recomputed to determine the new cash flow resulting from the gross withdrawal 172. The net effect cash flow difference is computed 173 by subtracting “old cash flow” from the “new cash flow”. The difference between gross withdrawal and net cash flow addition derives from tax liability incurred from withdrawals from investment accounts that may be taxable income (e.g. IRA). A deficit amount is computed based on subtracting the net effect from the request. If the deficit is below an insignificant threshold (e.g. $1), the request is deemed to have been fully satisfied and the process returns the “requested” amount 175. If the net effect is less than the tolerance (e.g. $1), it is presumed that the Investment domain has no resources to meet any demand. No grant will be allowed for this recursion. If the net is greater than tolerance, the algorithm makes an additional request to the net addition processor (i.e. the invocation of another instance of the net addition processor) equal to the remaining deficit. The net addition processor may require several recursive calls to converge to a solution within an acceptable level of tolerance (e.g. $1). Eventually, one of the stop controls will resolve the recursion. All net addition instances will resolve, such that the final result sum is reported back to the domain integration process that spawned the original net addition request.

The domain integration process will then proceed to its strategy execution phase 148. Before and after the strategy executes, a client's state is retested. The purpose of strategy execution is: (1) to resolve a non-viable state to prevent a case run failure, and (2) make decisions the strategist believes to improve the results of a case run. Strategy execution is described by the strategy executor in FIG. 18. Each edge in the EOL for a particular strategy variant 181 will be evaluated in the ordered sequence. An edge item contains the specification of the source and target domains (X,Y) and a set of triggers. If an edge item is an intra-domain edge (i.e. X=Y), the root instructs the appropriate domain to optimize according to internal methods specified by a domain author. If an edge item represents an inter-domain edge, a sorted list of eligible triggers is created 184 in accordance with the method described in 107. Each element in the sorted list of triggers met its underlying conditions. An eligible element represents a potential, but not necessarily executable, transaction. If the trigger list is void, there are no eligible triggers, no possible transaction, and the next edge item in the EOL is evaluated.

If the sorted list of triggers is not void, an attempt is to find one and only transaction that is executable. First, a transaction request is constructed from the current edge and trigger element 186 containing: (1) the domains (X,Y), (2) a requested amount, v, and (3) whether the transaction is contingent. A transaction is a matched buy-and-sell tradeoff, zero summed except for leakage (e.g. transaction costs). A domain query is made to “sell (at age, v)” from domain X. V′ represents the proposed grant. The grant may be less due to leakage or resource constraints related to the domain being “sold”. A contingent transaction is executable only if (offer−grant)<tolerance. If a transaction is non-contingent, the transaction is always executable. An executable transaction will cause the trigger loop 185 to exit immediately and pass the transaction to its next processing phase 187. If not, other elements in the trigger list will be similarly evaluated to see if one is executable. If no items in the trigger list are executable, the trigger loop terminates normally without having executed a domain tradeoff for this edge. The strategy execution process continues to evaluate the next edge in the edge order list.

Should an executable transaction be found, it is forwarded to the transaction processor 187, which instructs domain X to [symbol] sell (at age, v [symbol] ) [symbol] and domain Y to [symbol] buy (at age, v [symbol] ) [symbol] 188. How a domain [symbol] s resources (i.e. across its sub-types) should be liquidated to achieve a net sale of v [symbol] is left to the details of the domain author and is not the concern of the strategy. Similarly, the target domain resolves the internal allocation of the proceeds it receives from the transaction. For example, proceeds allocated within the debt domain might be used to retire existing debt or to purchase an income stream (e.g. annuity), etc.

Finally, the client state may have changed as a result of transaction execution. Therefore, the client state is evaluated for update purposes 189. The update may have altered the liquidity sub-state, including a possible resolution to a non-viable liquidity sub-state. Other edge items are evaluated in the strategy variant order until the end of the edge order list is reached. Two edges may have had identical triggers at the start of the strategy execution block 181. The first edge [symbol] s execution may alter the client state 189, thereby blocking the second edge from executing.

Upon full strategy execution, the domain integration process updates and queries the client [symbol] s state as part of the financial case run [symbol] s stop control. If the liquidity state is non-viable, the time iteration loop halts and the financial scratchpad in its incomplete state, with its [symbol] oldest age attained [symbol] less than client [symbol] s expected mortality, is reported back to the experiment run processor. Otherwise, the time iteration loop continues and if the loop completes, the case run may be successful, assuming the last iteration caused the [symbol] oldest age attained [symbol] to be set to the client [symbol] s expected mortality age.

Eventually, all financial case runs are completed in FIG. 14, thus concluding experimental runs. Control passes back to the HEDF [symbol] s post process 116. The HEDF will determine if a scenario is feasible. If it is feasible, the scenario processor decides whether to fine-tune 117. This decision is predicated on: (1) whether domain or strategy authors have publicly declared other domain control parameters, which would enable fine-grain decision making, and (2) whether additional fine-tuning is believed to have a substantive effect on the final result.

If a decision is made to fine-tune, the chosen optimum strategy variant and risk is held constant to another experiment 118, i.e. another invocation of HEDF in block 114. The [symbol] other publicly declared control parameters [symbol] (see 1 above), or subset thereof, now become the object of ANOVA testing. HEDA is re-dimensioned according to the set of control parameters to be tested. A suite of experimental case runs is repeated, this time by varying parameter choices. HEDF [symbol] s post-process will make specific choices of fine-grain parameters based on ANOVA.

The scenario process completes 25 by outputting a set of scenario output data 26. The output specification is depicted in FIG. 19 and as described below. The output data is derived consistent with the previously described architectures, but extended to include performance metrics. A single scenario record forms the output root, containing a unique ID that defines the scenario, the client ID, timestamp 190, and performance metrics related to ANOVA results. Referencing the scenario are the data hierarchies associated with: (1) strategy architecture 191, (2) the client and the CIE 192, (3) and the domain 193 architectures, all tied to the scenario using the unique scenario ID. The full or extracts of these three hierarchies then become output.

The strategy architecture 191 will output all strategies considered by this scenario (e.g. A, B, and possibly others). Each strategy is known by a unique strategy ID and a descriptor 194. The list of edges for each strategy is also generated in the output. The list is defined by the strategy they are linked to, the variant that produced the list, the order in which an edge appears in the list, the source and target domains 195. Each edge is given a unique edge ID.

In a preferred embodiment, other strategy data items are included only for the optimum strategy 196, including: (a) the set of triggers associated with each edge, the financial label, and criteria used to define each trigger per FIG. 10 specification, and (b) an edge log, used to report the frequency that the edge was triggered.

The client output 192 includes four major components: (1) the client handle, to link to the client description, which is already persistent, (2) preference attributes resulting from the gross feasibility adjuster 110 (e.g. retirement age, discretionary flag, expense level in retirement), (3) the deterministic CIE, as calculated by FIG. 12, and (4) optimum risk.

An extract of the domain financial scratchpads is generated 193 using several constructs: (1) a scratchpad reduction data template 197, (b) the static domain list corresponding to the baseline 198, and (c) the list of sub-types for each domain 199, which is non-static and therefore assigned a unique key. The scratchpad reduced data template 197 includes data items: (a) a field type identifier, whether the record relates to income, expense, cap gain, tax, balance, (see 48), (b) the age index, a zero-based index of a client [symbol] s age relative to their current age, (c) scenario ID ties the record to this scenario, and (d) three values, including the mean, an [symbol] upper [symbol] and [symbol] lower [symbol] range, as these values are derived from the most recent HEDF run (i.e. whether fine-tuned or only coarse) of m-cases for the optimum scenario. Only Non-zero [symbol] data reduced [symbol] scratchpads are generated across all domain sub-types according to a referential key needed to associate each data reduced record to its sub-type parent.

The output just described permits report generators to provide substantial flexibility in rendering views, such as: (1) ANOVA test results for the scenario, (2) presentation in-scope strategies fully described by the complete set of strategies 194, edges 195 and success ratios, (3) the optimum strategy, its associated triggers and strategic decision log as further specified by 196, (4) the client, the deterministic CIE, a client [symbol] s retirement feasibility, and optimum risk is described 192, (5) numerous report views of the domain composites are enabled by the sub-type financial scratchpad schema 193. Enabled views include, but are not limited to: (1) client net worth range data, spanning the client [symbol] s time dimension, summary and by domain; (2) client income, expense, and cash flow range data, spanning the client [symbol] s time dimension, summary and by domain; (3) client; The edge log enables reporting that identifies what strategic decisions are probable and constructive. These can generally be grouped into two categories: (1) near-term tactical decisions that conform to the optimum financial strategy, or (2) pre-emptive, strategic driven decisions.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and the scope of this invention.

Having thus described the invention, what is desired to be protected by Letters Patent is presented in the subsequently appended claims.

What is claimed is:

1. A method of deriving and measuring the feasibility of a client's retirement plan across a diverse spectrum of financial domains comprising:
a means for collecting an authenticated client's data specific to each financial domain;
a means for storing said data in a persistent data repository or volatile computer memory for future reference;
a means for automatically maintaining up-to-date external information relevant to a client's data for later use in scenario analyses and reports;
a means for deriving a set of dissimilar financial strategies and their associated decisions and calculating the probability of the success of said plans in accordance with varying client strategic risk using both deterministic and stochastic methods;
a means for selecting the optimum strategy and then further optimizing the said strategy and decisions towards a higher probability of success;
a means for responding to a plurality of requests for analysis of said optimized retirement plan strategy and decisions and reporting said strategy and decisions on a year-to-year basis from client's current age until estimated mortality.

2. The method recited in claim 1 wherein said financial domains include but are not limited to investments, defined benefit programs including social security and pensions, real estate, life insurance, state and federal taxes, debts/assets.

3. The method recited in claim 1 wherein the client data is collected by a computer program.

4. The method recited in claim 1 wherein external information is referenced automatically by a computer program over the Internet or a LAN/WAN.

5. The method recited in claim 1 wherein the optimized and fine-tuned retirement plan strategies, decisions and the probability of success are derived by a programmed digital computer.

6. The method recited in claim 1 wherein client strategic risk associated with an optimized strategy is determined by a programmed digital computer.

7. The method recited in claim 1 wherein the retirement plan's optimized strategy and decisions are reported to the client by a programmed digital computer.

8. A system for managing a plurality of client retirement planning cases, comprising;
a means which manages client's account and case data under secure encrypted protocols both providing privacy and preventing unauthorized access;
a means which collects client's financial data and other data used for scenario analyses and reports;
a means which automatically updates relevant information from external computerized sources for later use in scenario analyses and reports;
a means which derives and optimizes retirement plan strategies and decisions as well as calculates probabilities of success with optimized client risk on a year-to-year basis from client's current age until estimated mortality; and
a means which responds to a client's request for analysis and reports of said optimized retirement plan strategy and decisions and identifying said strategy and decisions on a year-to-year basis from client's current age until estimated mortality.

9. The system recited in claim 8 wherein said system is a computer program.

10. A system for managing a plurality of client cases and any number of concurrent client sessions consisting of clients interacting directly with the system using a computer web browser or similar user interface, or clients represented in proxy by remote computer systems communicating with the present invention using computer industry standard data protocols, said system comprising in combination:
a computer connected to a private wide bandwidth LAN/WAN network and the Internet including a program for deriving a client's optimum retirement strategy and actions with a calculated probability of success and an optimized client risk and responding to authorized external data requests for client analyses and reports as XML data documents using common data protocols such as SOAP,
a computer configured as a host web server for managing a plurality of concurrent client sessions over the Internet or LAN/WAN private network;
a computer configured as a database server for maintaining the persistent data repository (RDBMS) on a wide bandwidth LAN/WAN network;
a computer configured as a report server for rendering, formatting and presenting analytical results on a private wide bandwidth LAN/WAN network or the Internet; and
a plurality of concurrent connections between the host web server and external public domain systems on the Internet for referential data access.

11. The system recited in claim 10 wherein said client computers are connected to the Internet or LAN/WAN utilizing HTTP(unencrypted) or HTTPS (encrypted) protocol common to web browsers.

12. The system recited in claim 10 wherein said remote computer systems are connected to the Internet or LAN/WAN utilizing SOAP protocol.

13. The system recited in claim 10 wherein said LAN/WAN network is an Ethernet connection utilizing TCP/IP protocol.

14. The system recited in claim 10 wherein said web server is connected to Internet or LAN/WAN utilizing HTTP or HTTPS protocol.

15. The system recited in claim 10 wherein said database server is connected to the LAN/WAN over Ethernet utilizing TCP/IP protocol.

16. The system recited in claim 10 wherein said report server is connected to the LAN/WAN over Ethernet utilizing TCP/IP protocol.

17. The system recited in claim 10 wherein said external information providers are connected to the Internet or LAN/WAN using SOAP protocol and exchange documents in the XML data document format.

18. A method for executing a retirement plan scenario processor capable of deriving an optimized retirement plan scenario for a given client with appropriate output comprising;
a means for accessing all vital client input information from volatile computer memory or a persistent data repository;
a means for identifying, calculating and retaining client [symbol] s income and expenses across all financial domains and their respective sub-categories projecting year-to-year until client [symbol] s estimated mortality age is reached;
a means for determining the gross feasibility of scenario success as a control mechanism to continue the scenario run;
means for creating a minimum of two dissimilar strategies where each strategy allows permutations of decision paths to be tested as competing strategies;
means for allowing varying choices of client risk to be tested within each scenario;
means for generating case runs by creating volatility on long-range interest rate, market returns, and other uncertainty variables to be tested within an experimental framework;
means for applying experimental design techniques (e.g. ANOVA, zero-sum gaming) to frame and control experimentation of financial case runs for use in identifying an optimum strategy;
means for providing repetitive levels of scenario optimization resulting in the most preferable retirement plan as measured by the highest net worth value and for oldest viable age attained; and
means for allowing other computing systems or computerized reporting systems access to the resulting scenario data output as input to their analyses or reporting.

19. The method recited in claim 18 wherein said optimized retirement plan scenario output is delivered in a plurality of formats suitable for different types of consumers including but not limited to rendered and formatted electronic documents, e-mail attachments, web browser viewing sessions, unformatted computerized XML data documents or database access using SQL, ODBC or other data reader and reporting tools.

20. The method recited in claim 18 wherein said vital client input information may contain similar information for client [symbol] s spouse or partner and is considered appropriately in deriving the optimized strategy.

21. The method recited in claim 18 wherein said financial domains include but are not limited to retirement and non-retirement stock, fund, bond or other investments, defined benefit programs such as social security and pensions, real estate, life insurance, state and federal taxes, debts and assets.

22. The method recited in claim 18 wherein said client [symbol] s income is evaluated based on pre-retirement vs. post-retirement status and scaled according to an inflator/deflator models projected on a year-to-year basis until client [symbol] s estimated mortality age is reached.

23. The method recited in claim 18 wherein said client expenses include essential expenses which are always considered and discretionary expenses which are sometimes considered and scaled according to an inflator/deflator models projected year-to-year until client [symbol] s estimated mortality age is reached.

24. The method recited in claim 18 wherein said client strategic risk is tested up to five levels, including conservative, moderate, conservative-moderate, aggressive, and moderate-aggressive states for a given scenario.

25. The method recited in claim 18 wherein said gross feasibility indicates achievement of a minimum threshold success probability of achieving a complete retirement plan for the scenario where success is determined by sustained liquidity from the client [symbol] s current age until client [symbol] s estimated mortality.

26. A method for deriving a formal financial strategy from client [symbol] s current age until estimated mortality is reached comprising:
means for specifying the scope of a financial strategy by mapping all financial domains selected for consideration and types of financial strategic decisions into a canonical graphical construct, whereby graphical nodes refer to financial domains and graphical edges refer to types of strategic decisions that represent buy-sell transactions within or between financial domains;
means for building a minimum of two dissimilar strategies from a pre-defined set of financial domains and strategic decisions types;
means for creating four orthogonal edge ordered lists, whereby elements in the list refer to edges or strategic decision possibilities and the order these elements appear in a list connotes the priority sequence in which edges or decisions are evaluated in a single time instance;
means for specifying and testing the conditions that causes a buy-sell transaction to execute between two financial domains;
means for executing a fully defined financial strategy; and
means for defining the output result of a financial strategy, in accordance with the components that defined a strategy, complemented by performance metrics, inclusive of strategy success ratio and frequency by decision type over a client [symbol] s time dimension.

27. The method recited in claim 26 wherein said method is a computer program.

28. A system for deriving a formal financial strategy, comprising:
a strategy scope, for clarifying a financial strategy by mapping all financial domains selected for consideration and their strategic decision types into a graphical construct represented as data, whereby nodes refer to financial domains and edges refer to decisions that are buy-sell transactions within or between financial domains;
a strategy variant, for creating four orthogonal edge ordered lists, whereby list elements refer to edges and the list order connotes the priority sequence in which edges are evaluated in a single time instance;
a trigger, for specifying the conditions that cause a edge to execute a transaction between two financial domains;
a strategy creator, for building a minimum of two dissimilar strategies from a pre-defined set of financial domains and strategic decisions types;
a strategy executor, for executing a fully defined financial strategy based on a client and domain states, completely contained to said triggers, and completely contained to said variant; and
a strategy output generator, for defining the output result of a financial strategy, in accordance with the components that defined a strategy, complemented by performance metrics, inclusive of strategy success ratio and frequency by decision type at different client time instance.

29. The system recited in claim 28 wherein said system is a computer program.

30. A method for computing a financial case run, comprising:
means for iterating the time instance beginning from the client's current age towards estimated mortality, with a stop control if a non-viable or fail condition is first detected;
means for containing, controlling, coordinating and sequencing the processes associated with client, financial domains and strategy components within a single client time instance;
means for ensuring that client state information is kept current to ensure the integrity of any process that relies upon the accuracy of this information;
means for updating financial information related to all financial scratchpads during a single time instance to ensure the integrity of any process and output reporting mechanism dependent on this information;
means for combining both the deterministic and stochastic components from various financial scratchpads into a single composite scratchpad following a sequence that enforces logical dependence; and
means for making one or more recursive withdrawal requests to the investment domain with various stop controls, with a goal to grant the full original target request, accounting for differences between gross investment withdrawals versus net after taxes.

31. The method recited in claim 30 wherein said method is a computer program.

32. A system for computing a financial case run, comprising:
a timer, for iterating the time instance beginning from the client's current age towards estimated mortality, with a stop control if a non-viable or fail condition is first detected;
a domain integration processor, for containing, controlling, coordinating and sequencing the processes associated with client, financial domains and strategy in a single client time instance;
a client state manager, for ensuring that client state information is kept current to ensure the integrity of any process that relies upon the accuracy of this information;
a domain root, for invoking the financial domain processes that the root controls;
a scratchpad manager, for updating financial information related to all financial scratchpads during a single time instance to ensure the integrity of processes and reporting mechanisms that depend on this information;
a stochastic scratchpad calculator, for combining both the deterministic and stochastic components from various financial scratchpads into a single composite scratchpad in a sequence that is logically dependent; and
a net addition algorithm, for making one or more recursive withdrawal requests to the investment domain in accordance with stop controls, with a goal to grant the full original target request, accounting for differences between gross investment withdrawals versus net after taxes.

33. The system recited in claim 32 wherein said system is a computer program.
